(19) United States
(12) Patent Application Publication
(10) Pub. No.: US 2026/0126389 A1
(43) Pub. Date: May 7, 2026

(54) DEVICES AND METHODS FOR MEASURING BIOLOGICAL SAMPLE TOPOLOGY

(71) Applicant: Singular Genomics Systems, Inc., San Diego, CA (US)

(72) Inventors: Austin CORBETT, Carlsbad, CA (US); Yuji ISHITSUKA, San Diego, CA (US); Robert James STOVER, San Diego, CA (US)

(21) Appl. No.: 19/378,622

(22) Filed: Nov. 4, 2025

Related U.S. Application Data
(60) Provisional application No. 63/716,357, filed on Nov. 5, 2024.

(51) Int. Cl. G01N 21/64; G01N 1/28

(52) U.S. Cl. CPC G01N 21/6458; G01N 1/2813; G01N 1/286; G01N 2001/2873

(57) ABSTRACT

Disclosed herein, inter alia, are systems and methods for analyzing tissue thickness and structure.

### CROSS-REFERENCES TO RELATED APPLICATIONS

This application claims the benefit of U.S. Provisional Application No. 63/716,357, filed Nov. 5, 2024, which is incorporated herein by reference in its entirety and for all purposes.

### BACKGROUND

For many biological applications (e.g., spatial transcriptomics) it is necessary to prepare samples of biological tissues. This preparation includes both the sectioning of larger tissue samples into small, discrete, sections as well as adhering these sections onto a slide such that it can interface with a microscope. It is often useful, if not imperative, to understand the topography of the biological sample including local (micro-folds, voids, etc.) and global (overall thickness, gradients, etc.) structures. Disclosed herein, inter alia, are solutions to these and other problems in the art.

### BRIEF SUMMARY

In an aspect is provided a non-transitory computer-readable medium storing instructions that, when executed by a processor, perform a method for analyzing a tissue sample, the method including obtaining a first image of an tissue sample using a detection apparatus; obtaining a second image of the tissue sample using the detection apparatus; identifying, by one or more processors, a first plurality of positions corresponding to a plurality of fluorescent particles in the first image, and a second plurality of positions corresponding to a plurality of fluorescent particles in the second image; and computationally determining the distance between the first image and the second image. In embodiments, computationally determining the distance includes subtracting a distance from the first plurality of positions and the second plurality of positions.

In an aspect is a method of measuring a tissue sample attached to a first solid support, the method including: distributing a first plurality of fluorescent particles across a first surface of a first solid support; adhering a tissue sample to the first solid support; attaching a second solid support to the first solid support; introducing a solution to the second solid support wherein solution includes a second plurality of fluorescent particles that adhere to an exposed region of the tissue sample; and acquiring images of the first plurality of fluorescent particles and the second plurality of fluorescent particles across a cross section of the tissue sample. In embodiments, the method includes iteratively acquiring images across a plurality of cross sections. In embodiments, the method includes determining the thickness of the tissue sample.

### BRIEF DESCRIPTION OF THE DRAWINGS

FIGS. 1A-1B. FIG. 1A provides a schematic for preparing a composition described herein, wherein the composition includes a first solid support including a plurality of a first fluorescent particle attached to the first solid support, a tissue section immobilized to the first solid support, a plurality of a second fluorescent particle, and a second solid support. A sample slide (e.g., a first solid support as described herein) is prepared, wherein the slide includes a resist as described herein. A plurality of focusing beads (e.g., a plurality of first fluorescent particles as described herein) is distributed across the surface of the resist as shown in step 2 of FIG. 1A. Following the deposition of the plurality of the first fluorescent particle at the optimal density, a tissue section as described herein is adhered onto the first solid support, followed by the affixing the second solid support onto the first solid support (as shown in steps 3 and 4 in FIG. 1A), wherein the second solid support includes drilled ports and/or fluidic channels. After affixing the second solid support to the first solid support, a solution including a plurality of the second fluorescent particle as described herein is pushed through the channel of the second solid support to facilitate adherence of the second fluorescent particle to exposed regions of the tissue section (as shown as step 5 of FIG. 1A). Alternatively, in embodiments, after adhering the tissue section onto the first solid support, a solution including a plurality of the second fluorescent particle as described herein is introduced to facilitate adherence of the second fluorescent particle to exposed regions of the tissue section. FIG. 1B provides the orientation of the tissue slide including the plurality of the first fluorescent particle and the plurality of the second fluorescent particle. The top of the tissue slide corresponds to the interface between the tissue section and the first solid support, and the bottom of the tissue slide corresponds to the interface between tissue section and the second solid support.

FIG. 2 illustrates a punch device used to cut out a region of tissue with desired characteristics to be used with the composition, systems, and methods described herein (e.g., shown as step 3 in FIG. 1A). The cutter portion of the punch provided in FIG. 2 is removed, flipped, and placed in a receiving array holding the first solid support described herein (as shown in steps 1-4 in FIG. 2). After the punch devices are loaded, a glass slide (e.g., a first solid support as described herein) in a holder is aligned over the tissue array (as shown in step 4 of FIG. 2). An array of pistons plunges into the punch device to push tissue samples onto the glass surface from the carrier side (as illustrated in step 4 of FIG. 2). Following incubation on a heat plate (e.g., heating the assembly for 2-4 hours at 60° C.), the receiving array, pistons, and punch devices are removed such that the sample is retained on the sample slide (e.g., the first solid support as described herein as shown in steps 5 and 6 of FIG. 2). The embedding material may be removed, for example when the embedding material is paraffin wax by contacting the construct with an organic solvent such as xylene or heptane, leaving the biological sample on the construct.

FIG. 3 illustrates the movement of the objective lens along the z-axis at defined step sizes to focus on the first fluorescent particle and second fluorescent particle through the entire cross section of the tissue section across its entire surface area. As the objective lens moves along the z-axis to a (n) step defined by the step size, images are acquired iteratively, wherein an image is acquired by focusing on the first fluorescent particle and/or second fluorescent particle prior to the acquisition of the image of the tissue section at the (n+1) step.

FIGS. 4A-4D provides a region of interest (ROI) throughout imaging processing. FIG. 4A provides the raw image of the ROI prior to any image processing described herein. FIG. 4B provides the ROI following the application of a background subtraction described herein. FIG. 4C provides the ROI following the application of a background subtraction described herein and a low-pass filter such as a Gaussian blur to reduce noise that is not associated with the focus feature (i.e., the first fluorescent particle and/or second fluorescent particle). FIG. 4D provides the ROI following the calculation of a Laplacian Operator and the variance of the Laplacian Operator to facilitate edge detection. As shown in FIG. 4D, the edges of the focus features and the variance of the Laplacian Operator as the focus features become more in focus.

FIG. 5 provides the plot of the variance of the Laplacian Operator against the z-position (μm) for a single ROI to determine the tissue thickness at a given ROI. Plotting the variance of the Laplacian Operator (LV), for a specific ROI, against the z-position, (derived from the encoder of the stage operating the objective lens position and scaled by index of refraction of the first solid support), peaks are observed. The measurement of tissue thickness at a given ROI begins with the initial identification of coarse peaks, followed by refining the peaks positions by applying second order polynomial fits about the initial peak positions. Using the method described herein, the z-position corresponding to where the first fluorescent particle and/or second fluorescent particle are in focus can be ascertained with a resolution that significantly exceeds the step size of the cross-section (z) stack. FIG. 5 shows two peaks and the distance between these two peaks is the inferred tissue thickness.

FIGS. 6A-6B. FIG. 6A provides a fluorescent microscope image of a single cross section. FIG. 6B shows a reconstructed topological heatmap of the section shown in FIG. 6A using the image acquisition and image analysis methods described herein. The heatmap scale is provided in μm.

FIGS. 7A-7F. FIG. 7A provides a stitched fluorescent image montage of 24 tissue punches onto lanes of a 4-lane flow cell, where each lane included a tissue punch from kidney, lymph, lung, breast, colon, and tonsil. Four tissue sections were imaged for each tissue type (e.g., four kidney punches were used, where one punch of the kidney section was adhered onto the surface of each lane of the 4-lane flow cell). FIG. 7B provides box and whisker plots for calculated thickness of a section of kidney tissue per ROI on the flow cell, wherein the image was acquired with 100 nm, 200 nm, 300 nm, 400 nm, and 500 nm step sizes. FIGS. 7C-7E demonstrates the impact of ROI size and stride length on spatial resolution of topological mapping of the tonsil tissue section in lane 1 (denoted as Lane 1; Section 6). Topological heatmaps show the non-scanning axis (μm) plotted against the scanning axis (μm), and the scale of the heatmap is provided in μm. FIG. 7C provides a calculated measured thickness of 6.083 μm when using a ROI window of 300 pixels and stride length of 100 pixels. FIG. 7D provides a calculated measured thickness of 5.979 μm when using a ROI window of 500 pixels and stride length of 200 pixels. FIG. 7E provides a calculated measured thickness of 5.127 μm when using a ROI window of 500 pixels and stride length of 1,000 pixels. As shown in FIGS. 7C-7E, the increase of ROI size and stride length correlates to reduced spatial resolution and increased variability in the mean measured tissue thickness. FIG. 7F shows a reconstructed topological heatmap of the tissue sections shown in FIG. 7A using the image acquisition and image analysis methods described herein. The heatmap scale is provided in μm. Calculated thickness for each tissue section is shown beneath each tissue section.

FIG. 8. Violin plot of measured tissue thickness at sequencing start vs tissue type. Each distribution in the plot is a collection of several different samples, but all belong to the listed tissue type. All tissue samples included in this plot were sectioned using a calibrated microtome set to section at 5 μm.

### DETAILED DESCRIPTION

The aspects and embodiments described herein relate to compositions, systems, and methods for measuring tissue thickness.

### I. Definitions

All patents, patent applications, articles and publications mentioned herein, both supra and infra, are hereby expressly incorporated herein by reference in their entireties.

Unless defined otherwise herein, all technical and scientific terms used herein have the same meaning as commonly understood by one of ordinary skill in the art to which this disclosure belongs. Various scientific dictionaries that include the terms included herein are well known and available to those in the art. Although any methods and materials similar or equivalent to those described herein find use in the practice or testing of the disclosure, some preferred methods and materials are described. Accordingly, the terms defined immediately below are more fully described by reference to the specification as a whole. It is to be understood that this disclosure is not limited to the particular methodology, protocols, and reagents described, as these may vary, depending upon the context in which they are used by those of skill in the art. The following definitions are provided to facilitate understanding of certain terms used frequently herein and are not meant to limit the scope of the present disclosure.

As used herein, the singular terms “a”, “an”, and “the” include the plural reference unless the context clearly indicates otherwise. Reference throughout this specification to, for example, “one embodiment”, “an embodiment”, “another embodiment”, “a particular embodiment”, “a related embodiment”, “a certain embodiment”, “an additional embodiment”, or “a further embodiment” or combinations thereof means that a particular feature, structure or characteristic described in connection with the embodiment is included in at least one embodiment of the present disclosure. Thus, the appearances of the foregoing phrases in various places throughout this specification are not necessarily all referring to the same embodiment. Furthermore, the particular features, structures, or characteristics may be combined in any suitable manner in one or more embodiments.

As used herein, the term “about” means a range of values including the specified value, which a person of ordinary skill in the art would consider reasonably similar to the specified value. In embodiments, the term “about” means within a standard deviation using measurements generally acceptable in the art. In embodiments, about means a range extending to +/−10% of the specified value. In embodiments, about means the specified value.

Throughout this specification, unless the context requires otherwise, the words “comprise”, “comprises” and “comprising” will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

As used herein, the term “associated” or “associated with” can mean that two or more species are identifiable as being co-located at a point in time. An association can mean that two or more species are or were within a similar container. An association can be an informatics association, where for example digital information regarding two or more species is stored and can be used to determine that one or more of the species were co-located at a point in time. An association can also be a physical association. In some instances two or more associated species are “tethered”, “coated”, “attached”, or “immobilized” to one another or to a common solid or semisolid support (e.g. a receiving substrate). An association may refer to a relationship, or connection, between two entities. For example, a barcode sequence may be associated with a particular target by binding a probe including the barcode sequence to the target. In embodiments, detecting the associated barcode provides detection of the target. Associated may refer to the relationship between a sample and the DNA molecules, RNA molecules, or polynucleotides originating from or derived from that sample. These relationships may be encoded in oligonucleotide barcodes, as described herein. A polynucleotide is associated with a sample if it is an endogenous polynucleotide, i.e., it occurs in the sample at the time the sample is obtained, or is derived from an endogenous polynucleotide. For example, the RNAs endogenous to a cell are associated with that cell. cDNAs resulting from reverse transcription of these RNAs, and DNA amplicons resulting from PCR amplification of the cDNAs, contain the sequences of the RNAs and are also associated with the cell. The polynucleotides associated with a sample need not be located or synthesized in the sample, and are considered associated with the sample even after the sample has been destroyed (for example, after a cell has been lysed). Barcoding can be used to determine which polynucleotides in a mixture are associated with a particular sample. In embodiments, a proximity probe is associated with a particular barcode, such that identifying the barcode identifies the probe with which it is associated. Because the proximity probe specifically binds to a target, identifying the barcode thus identifies the target.

In some embodiments, a nucleic acid includes a label. As used herein, the term “label” or “labels” is used in accordance with their plain and ordinary meanings and refer to molecules that can directly or indirectly produce or result in a detectable signal either by themselves or upon interaction with another molecule. In embodiments, a label is a nucleic acid sequence associated with a detection agent for the detection of biomolecules of interest in tissue sections or cells. Non-limiting examples of detectable labels include fluorescent dyes, biotin, digoxin, haptens, and epitopes. In general, a dye is a molecule, compound, or substance that can provide an optically detectable signal, such as a colorimetric, luminescent, bioluminescent, chemiluminescent, phosphorescent, or fluorescent signal. In embodiments, the label is a dye. In embodiments, the dye is a fluorescent dye. Non-limiting examples of dyes, some of which are commercially available, include CF® dyes (Biotium, Inc.), Alexa Fluor® dyes (Thermo Fisher), DyLight® dyes (Thermo Fisher), Cy® dyes (GE Healthscience), IRDye® dyes (Li-Cor Biosciences, Inc.), and HiLyte™ dyes (Anaspec, Inc.). In embodiments, a particular nucleotide type is associated with a particular label, such that identifying the label identifies the nucleotide with which it is associated. In embodiments, the label is luciferin that reacts with luciferase to produce a detectable signal in response to one or more bases being incorporated into an elongated complementary strand, such as in pyrosequencing. In embodiment, a nucleotide includes a label (such as a dye). In embodiments, the label is not associated with any particular nucleotide, but detection of the label identifies whether one or more nucleotides having a known identity were added during an extension step (such as in the case of pyrosequencing). Examples of detectable agents (i.e., labels) include imaging agents, including fluorescent and luminescent substances, molecules, or compositions, including, but not limited to, a variety of organic or inorganic small molecules commonly referred to as “dyes,” “labels,” or “indicators.” Examples include fluorescein, rhodamine, acridine dyes, Alexa Fluor® dyes, and cyanine dyes. In embodiments, the detectable moiety is a fluorescent molecule (e.g., acridine dye, cyanine, dye, fluorine dye, oxazine dye, phenanthridine dye, or rhodamine dye). In embodiments, the detectable moiety is a fluorescent molecule (e.g., acridine dye, cyanine, dye, fluorine dye, oxazine dye, phenanthridine dye, or rhodamine dye). The term “cyanine” or “cyanine moiety” as described herein refers to a detectable moiety containing two nitrogen groups separated by a polymethine chain. In embodiments, the cyanine moiety has 3 methine structures (i.e., cyanine 3 or Cy3®). In embodiments, the cyanine moiety has 5 methine structures (i.e., cyanine 5 or Cy5®). In embodiments, the cyanine moiety has 7 methine structures (i.e., cyanine 7 or Cy7®).

As used herein, the term “biomolecule” refers to an agent (e.g., a compound, macromolecule, or small molecule), and the like derived from a biological system (e.g., an organism). The biomolecule may contain multiple individual components that collectively construct the biomolecule, for example, in embodiments, the biomolecule is a polynucleotide wherein the polynucleotide is composed of nucleotide monomers. The biomolecule may be or may include DNA, RNA, organelles, carbohydrates, lipids, proteins, or any combination thereof. These components may be extracellular. In some examples, the biomolecule may be referred to as a clump or aggregate of combinations of components. In some instances, the biomolecule may include one or more constituents of a cell but may not include other constituents of the cell. In embodiments, a biomolecule is a molecule produced by a biological system (e.g., an organism). In embodiments, a biomolecule may be referred to as an analyte. Analytes can be broadly classified into one of two groups: nucleic acid analytes, and non-nucleic acid analytes. Examples of non-nucleic acid analytes include, but are not limited to, lipids, carbohydrates, peptides, proteins, glycoproteins (N-linked or O-linked), lipoproteins, phosphoproteins, specific phosphorylated or acetylated variants of proteins, amidation variants of proteins, hydroxylation variants of proteins, methylation variants of proteins, ubiquitylation variants of proteins, sulfation variants of proteins, viral proteins (e.g., viral capsid, viral envelope, viral coat, viral accessory, viral glycoproteins, viral spike, etc.), extracellular and intracellular proteins, antibodies, and antigen binding fragments. In embodiments, the analytes within a cell can be localized to subcellular locations, including, for example, organelles, e.g., mitochondria, Golgi apparatus, endoplasmic reticulum, chloroplasts, endocytic vesicles, exocytic vesicles, vacuoles, lysosomes, etc. In embodiments, analyte(s) can be peptides or proteins, including antibodies and/or enzymes. In embodiments, an analyte can be detected indirectly, such as through detection of an intermediate agent, for example, a ligation product or an analyte capture agent (e.g., an oligonucleotide-conjugated antibody), such as those described herein.

As used herein, the term “biological system” refers to a virus, cell, cell derivative, cell nucleus, cell organelle, cell constituent and the like derived from a biological sample. Examples of a cell organelle include, without limitation, a nucleus, endoplasmic reticulum, a ribosome, a Golgi apparatus, an endoplasmic reticulum, a chloroplast, an endocytic vesicle, an exocytic vesicle, a vacuole, and a lysosome. The biological system (e.g., an organism) may contain multiple individual components, such as viruses, cells, cell derivatives, cell nuclei, cell organelles and cell constituents, including combinations of different of these and other components. The biological system may include DNA, RNA, organelles, proteins, or any combination thereof. These components may be extracellular. In some examples, the biological system may be referred to as a clump or aggregate of combinations of components. In some instances, the biological system may include one or more constituents of a cell but may not include other constituents of the cell. An example of such constituents include nucleus or an organelle. A cell may be a live or viable cell. The live cell may be capable of being cultured, for example, being cultured when enclosed in a gel or polymer matrix or cultured when including a gel or polymer matrix. A biological system may include a single cell and/or a single nuclei from a cell.

The terms “particle” and “bead” are used interchangeably and mean a small body made of a rigid or semi-rigid material. The body can have a shape characterized, for example, as a sphere, oval, microsphere, or other recognized particle shape whether having regular or irregular dimensions. The term “particle” does not indicate any particular shape. The shapes and sizes of a collection of particles may be different or about the same (e.g., within a desired range of dimensions, or having a desired average or minimum dimension). A particle may be substantially spherical (e.g., microspheres) or have a non-spherical or irregular shape, such as cubic, cuboid, pyramidal, cylindrical, conical, oblong, or disc-shaped, and the like. In embodiments, the particle has the shape of a sphere, cylinder, spherocylinder, or ellipsoid. In embodiments, a particle is a microsphere used as a calibration tool to calibrate and assess the z-axis used in imaging-based methods for in situ spatial sequencing applications. In embodiments, a particle includes a focusing bead. In embodiments, the methods described herein include focusing on the beads at different depths to calibrate and image in three dimensions.

As used herein, the terms “sequencing”, “sequence determination”, “determining a nucleotide sequence”, and the like include determination of a partial or complete sequence information (e.g., a sequence) of a polynucleotide being sequenced, and particularly physical processes for generating such sequence information. That is, the term includes sequence comparisons, consensus sequence determination, contig assembly, fingerprinting, and like levels of information about a target polynucleotide, as well as the express identification and ordering of nucleotides in a target polynucleotide. The term also includes the determination of the identification, ordering, and locations of one, two, or three of the four types of nucleotides within a target polynucleotide. In some embodiments, a sequencing process described herein includes contacting a template and an annealed primer with a suitable polymerase under conditions suitable for polymerase extension and/or sequencing.

As used herein, the term “sequencing read” is used in accordance with its plain and ordinary meaning and refers to an inferred sequence of nucleotide bases (or nucleotide base probabilities) corresponding to all or part of a single polynucleotide fragment. A sequencing read may include 10, 20, 30, 40, 50, 60, 70, 80, 90, 100, 150, 200, 250, or more nucleotide bases. In embodiments, a sequencing read includes reading a barcode sequence and a template nucleotide sequence. In embodiments, a sequencing read includes reading a template nucleotide sequence. In embodiments, a sequencing read includes reading a barcode and not a template nucleotide sequence. Reads of length 20-40 base pairs (bp) are referred to as ultra-short. Typical sequencers produce read lengths in the range of 100-500 bp. Read length is a factor which can affect the results of biological studies. For example, longer read lengths improve the resolution of de novo genome assembly and detection of structural variants. In embodiments, a sequencing read includes reading a barcode and a template nucleotide sequence. In embodiments, a sequencing read includes reading a template nucleotide sequence. In embodiments, a sequencing read includes reading a barcode and not a template nucleotide sequence. In embodiments, a sequencing read includes a computationally derived string corresponding to the detected label. In some embodiments, a sequencing read may include 300, 400, 500, 600, 700, 800, 900, 1,000, 1,100, 1,200, 1,300, 1,400, 1,500, or more nucleotide bases.

Provided herein are methods, systems, and compositions for analyzing a sample (e.g., sequencing nucleic acids within a sample) in situ. The term “in situ” is used in accordance with its ordinary meaning in the art and refers to a sample surrounded by at least a portion of its native environment, such as may preserve the relative position of two or more elements. For example, an extracted human cell obtained is considered in situ when the cell is retained in its local microenvironment so as to avoid extracting the target (e.g., nucleic acid molecules or proteins) away from their native environment. An in situ sample (e.g., a cell) can be obtained from a suitable subject. An in situ cell sample may refer to a cell and its surrounding milieu, or a tissue. A sample can be isolated or obtained directly from a subject or part thereof. In embodiments, the methods described herein (e.g., sequencing a plurality of target nucleic acids of a cell in situ) are applied to an isolated cell (i.e., a cell not surrounded by least a portion of its native environment). For the avoidance of any doubt, when the method is performed within a cell (e.g., an isolated cell) the method may be considered in situ. In some embodiments, a sample is obtained indirectly from an individual or medical professional. A sample can be any specimen that is isolated or obtained from a subject or part thereof. A sample can be any specimen that is isolated or obtained from multiple subjects. Non-limiting examples of specimens include fluid or tissue from a subject, including, without limitation, blood or a blood product (e.g., serum, plasma, platelets, buffy coats, or the like), umbilical cord blood, chorionic villi, amniotic fluid, cerebrospinal fluid, spinal fluid, lavage fluid (e.g., lung, gastric, peritoneal, ductal, ear, arthroscopic), a biopsy sample, celocentesis sample, cells (blood cells, lymphocytes, placental cells, stem cells, bone marrow derived cells, embryo or fetal cells) or parts thereof (e.g., mitochondrial, nucleus, extracts, or the like), urine, feces, sputum, saliva, nasal mucous, prostate fluid, lavage, semen, lymphatic fluid, bile, tears, sweat, breast milk, breast fluid, the like or combinations thereof. Non-limiting examples of tissues include organ tissues (e.g., liver, kidney, lung, thymus, adrenals, skin, bladder, reproductive organs, intestine, colon, spleen, brain, the like or parts thereof), epithelial tissue, hair, hair follicles, ducts, canals, bone, eye, nose, mouth, throat, ear, nails, the like, parts thereof or combinations thereof. A sample may include cells or tissues that are normal, healthy, diseased (e.g., infected), and/or cancerous (e.g., cancer cells). A sample obtained from a subject may include cells or cellular material (e.g., nucleic acids) of multiple organisms (e.g., virus nucleic acid, fetal nucleic acid, bacterial nucleic acid, parasite nucleic acid). A sample may include a cell and RNA transcripts. A sample can include nucleic acids obtained from one or more subjects. In some embodiments a sample includes nucleic acid obtained from a single subject. A subject can be any living or non-living organism, including but not limited to a human, non-human animal, plant, bacterium, fungus, virus, or protist. A subject may be any age (e.g., an embryo, a fetus, infant, child, adult). A subject can be of any sex (e.g., male, female, or combination thereof). A subject may be pregnant. In some embodiments, a subject is a mammal. In some embodiments, a subject is a plant. In some embodiments, a subject is a human subject. A subject can be a patient (e.g., a human patient). In some embodiments a subject is suspected of having a genetic variation or a disease or condition associated with a genetic variation.

As used herein the term “determine” can be used to refer to the act of ascertaining, establishing or estimating. A determination can be probabilistic. For example, a determination can have an apparent likelihood of at least 50%, 75%, 90%, 95%, 98%, 99%, 99.9% or higher. In some cases, a determination can have an apparent likelihood of 100%. An exemplary determination is a maximum likelihood analysis or report. As used herein, the term “identify,” when used in reference to a thing, can be used to refer to recognition of the thing, distinction of the thing from at least one other thing or categorization of the thing with at least one other thing. The recognition, distinction or categorization can be probabilistic. For example, a thing can be identified with an apparent likelihood of at least 50%, 75%, 90%, 95%, 98%, 99%, 99.9% or higher. A thing can be identified based on a result of a maximum likelihood analysis. In some cases, a thing can be identified with an apparent likelihood of 100%.

The term “image” is used according to its ordinary meaning and refers to a representation of all or part of an object. The representation may be an optically detected reproduction. For example, an image can be obtained from fluorescent, luminescent, scatter, or absorption signals. The part of the object that is present in an image can be the surface or other xy plane of the object. Typically, an image is a 2 dimensional representation of a 3 dimensional object. An image may include signals at differing intensities (i.e., signal levels). An image can be provided in a computer readable format or medium. An image is derived from the collection of focus points of light rays coming from an object (e.g., the sample), which may be detected by any image sensor.

As used herein, the term “signal” is intended to include, for example, fluorescent, luminescent, scatter, or absorption impulse or electromagnetic wave transmitted or received. Signals can be detected in the ultraviolet (UV) range (about 200 to 390 nm), visible (VIS) range (about 391 to 770 nm), infrared (IR) range (about 0.771 to 25 microns), or other range of the electromagnetic spectrum. The term “signal level” refers to an amount or quantity of detected energy or coded information. For example, a signal may be quantified by its intensity, wavelength, energy, frequency, power, luminance, or a combination thereof. Other signals can be quantified according to characteristics such as voltage, current, electric field strength, magnetic field strength, frequency, power, temperature, etc. Absence of signal is understood to be a signal level of zero or a signal level that is not meaningfully distinguished from noise.

The term “xy coordinates” refers to information that specifies location, size, shape, and/or orientation in an xy plane. The information can be, for example, numerical coordinates in a Cartesian system. The coordinates can be provided relative to one or both of the x and y axes or can be provided relative to another location in the xy plane (e.g., a fiducial). The term “xy plane” refers to a 2 dimensional area defined by straight line axes x and y. When used in reference to a detecting apparatus and an object observed by the detector, the xy plane may be specified as being orthogonal to the direction of observation between the detector and object being detected.

As used herein, the “z-axis” refers to an axis in a 3-dimensional area defined by straight line axes x, y, and z, wherein the z-axis is perpendicular to the x-axis and y-axis. In embodiments, the methods described herein include imaging along the z-axis by focusing on the beads at different depths to calibrate and image in three dimensions.

As used herein, the term “tissue section” refers to a piece of tissue that has been obtained from a subject, optionally fixed and attached to a surface, e.g., a microscope slide.

The term “spatial proximity” as used herein refers to a criterion or metric that groups cells based on their physical locations relative to each other. For example, cells that are geographically closer are more likely to be grouped together, suggesting that their spatial arrangement may reflect underlying biological or functional similarities. Spatial proximity may be reported as a value or vector indicating the relative distance between two or more cells.

As used herein, the term “infrared (IR) reflective coating” refers to a material deposited onto a solid support capable of reflecting some or all infrared light. The effectiveness of an IR reflective coating is noted in its capability to reflect light that falls within the infrared spectrum, specifically light with wavelengths ranging from about 750 nanometers (nm) to about 1,000 micrometers (μm). Examples of IR reflective coating include, but are not limited to, metal oxides and silver. In embodiments, the infrared (IR) reflective coatings may include materials such as gold, aluminum, tantalum oxide, chromium, zinc sulfide, and titanium dioxide. Gold is known for its excellent reflectivity, particularly in the near-infrared range; aluminum is a lightweight metal with a natural oxide layer that enhances its IR reflectivity; chromium, a metal noted for its durable and reflective characteristics, zinc sulfide, a compound frequently used in optical components due to its transparency and reflectivity in the infrared range, and titanium dioxide, a compound widely used for its high refractive index and strong IR reflective properties, are exemplary of the diverse range of materials that can be employed as IR reflective coatings. In embodiments, the infrared (IR) reflective coating includes one or more layers of silicon dioxide (SiO₂) and tantalum pentoxide (Ta₂O₅). The IR reflective coating may reflect a portion of the total radiation.

As used herein, the term “interfacial”, or “interfacial layer”, is used in accordance with its plain ordinary meaning and refers to the boundary between any two bulk phases (gas, liquid, or solid) in contact where the properties differ from the properties of the bulk phases. In embodiments, an interfacial layer includes water. Interfacial water differs from bulk water in a number of properties, for example, interfacial water has a higher heat capacity than bulk water because more energy is necessary to break its hydrogen bonds. The arrangement and structure of the interfacial water layer varies depending on the structure of the hydrophilic and/or hydrophobic surface(s) the water layer is in contact with. Additional properties of interfacial water may be found in, e.g., Mentre P. J. Biol. Phys. and Chem. 2004; 4:115-123 and Tanaka M. Front. Chem. 2020; 8:165, which are incorporated herein by reference in their entirety.

As used herein, the terms “solid support” and “substrate” and “substrate surface” and “solid surface” refers to discrete solid or semi-solid surfaces to which a plurality of functional groups (e.g., bioconjugate reactive moieties or specific binding reagents) may be attached. A solid support may encompass any type of solid, porous, or hollow sphere, ball, cylinder, or other similar configuration composed of plastic, ceramic, metal, or polymeric material (e.g., hydrogel) onto which a nucleic acid may be immobilized (e.g., covalently or non-covalently). A solid support may include a discrete particle that may be spherical (e.g., microspheres) or have a non-spherical or irregular shape, such as cubic, cuboid, pyramidal, cylindrical, conical, oblong, or disc-shaped, and the like. A bead can be non-spherical in shape. A solid support may be used interchangeably with the term “bead.” A solid support may further include a polymer or hydrogel on the surface to which the primers are attached. Exemplary solid supports include, but are not limited to, glass and modified or functionalized glass, plastics (including acrylics, polystyrene and copolymers of styrene and other materials, polypropylene, polyethylene, polybutylene, polyurethanes, Teflon™, cyclic olefin copolymers, polyimides etc.), nylon, ceramics, resins, Zeonor®, silica or silica-based materials including silicon and modified silicon, carbon, metals, inorganic glasses, optical fiber bundles, photopatternable dry film resists, UV-cured adhesives and polymers. Particularly useful solid supports for some embodiments have at least one surface located on a microplate. Particularly useful solid supports for some embodiments have at least one surface located on a microplate within a flow cell. Solid surfaces can also be varied in their shape depending on the application in a method described herein. For example, a solid surface useful herein can be planar, or contain regions which are concave or convex. In embodiments, the geometry of the concave or convex regions (e.g., wells) of the solid surface conform to the size and shape of a substantially circular particle to maximize the contact between the particle. In embodiments, the wells of an array are randomly located such that nearest neighbor wells have random spacing between each other. Alternatively, in embodiments the spacing between the wells can be ordered, for example, forming a regular pattern. The term solid substrate is encompassing of a substrate (e.g., a microplate or flow cell) having a surface including a polymer coating covalently attached thereto. In embodiments, the solid support (e.g., solid substrate) includes a functionalized glass slide.

Broadly speaking, for nucleic acid sequencing and spatial biology applications, a flow cell may be considered a reaction chamber that contains one or more nucleic acid templates, to which nucleotides and ancillary reagents are iteratively applied and washed away. The flow cell allows for imaging of the sites at which the nucleic acids are bound, and resulting image data is used for the desired analysis.

In embodiments, the solid substrate is a flow cell. The term “flow cell” as used herein refers to a chamber including a solid surface across which one or more fluid reagents can be flowed. Examples of flow cells and related fluidic systems and detection platforms that can be readily used in the methods of the present disclosure are described, for example, in Bentley et al., Nature 456:53-59 (2008). In certain embodiments a substrate includes a surface (e.g., a surface of a flow cell, a surface of a tube, a surface of a chip), for example a metal surface (e.g., steel, gold, silver, aluminum, silicon and copper). In embodiments a substrate (e.g., a substrate surface) is coated and/or includes functional groups and/or inert materials. In certain embodiments a substrate includes a bead, a chip, a capillary, a plate, a membrane, a wafer (e.g., silicon wafers), a comb, or a pin for example. In some embodiments a substrate includes a bead and/or a nanoparticle. A substrate can be made of a suitable material, non-limiting examples of which include a plastic or a suitable polymer (e.g., polycarbonate, poly(vinyl alcohol), poly(divinylbenzene), polystyrene, polyamide, polyester, polyvinylidene difluoride (PVDF), polyethylene, polyurethane, polypropylene, and the like), borosilicate, glass, nylon, Wang resin, Merrifield resin, metal (e.g., iron, a metal alloy, sepharose, agarose, polyacrylamide, dextran, cellulose and the like or combinations thereof. In embodiments a substrate includes a magnetic material (e.g., iron, nickel, cobalt, platinum, aluminum, and the like). In embodiments a substrate includes a magnetic bead (e.g., DYNABEADS®, hematite, AMPure XP). Magnets can be used to purify and/or capture nucleic acids bound to certain substrates (e.g., substrates including a metal or magnetic material). The flow cell is typically a glass slide containing small fluidic channels (e.g., a glass slide 75 mm×25 mm×1 mm having one or more channels), through which sequencing solutions (e.g., polymerases, nucleotides, and buffers) may traverse. Though typically glass, suitable flow cell materials may include polymeric materials, plastics, silicon, quartz (fused silica), Borofloat® glass, silica, silica-based materials, carbon, metals, an optical fiber or optical fiber bundles, sapphire, or plastic materials such as COCs and epoxies. The particular material can be selected based on properties desired for a particular use. For example, materials that are transparent to a desired wavelength of radiation are useful for analytical techniques that will utilize radiation of the desired wavelength. Conversely, it may be desirable to select a material that does not pass radiation of a certain wavelength (e.g., being opaque, absorptive, or reflective). In embodiments, the material of the flow cell is selected due to the ability to conduct thermal energy. In embodiments, a flow cell includes inlet and outlet ports and a flow channel extending there between. In embodiments, the term “flow cell” refers to a vessel having a chamber (e.g., a flow channel or “lane”) where a reaction can be carried out, an inlet for delivering reagent(s) to the chamber, and an outlet for removing reagent(s) from the chamber.

As used herein, the term “channel” refers to a passage in or on a substrate material that directs the flow of a fluid. A channel may run along the surface of a substrate, or may run through the substrate between openings in the substrate. A channel can have a cross section that is partially or fully surrounded by substrate material (e.g., a fluid impermeable substrate material). For example, a partially surrounded cross section can be a groove, trough, furrow or gutter that inhibits lateral flow of a fluid. The transverse cross section of an open channel can be, for example, U-shaped, V-shaped, curved, angular, polygonal, or hyperbolic. A channel can have a fully surrounded cross section such as a tunnel, tube, or pipe. A fully surrounded channel can have a rounded, circular, elliptical, square, rectangular, or polygonal cross section. In particular embodiments, a channel can be located in a flow cell, for example, being embedded within the flow cell. A channel in a flow cell can include one or more windows that are transparent to light in a particular region of the wavelength spectrum. In embodiments, the channel contains one or more polymers of the disclosure. In embodiments, the channel is filled by the one or more polymers, and flow through the channel (e.g., as in a sample fluid) is directed through the polymer in the channel. In embodiments, the tissue is in a channel of a flow cell.

As used herein, the term “gasket” refers to an element that separates the first solid support and the second solid support to define a reaction chamber on the second solid support, wherein the reaction chamber includes a defined gap or channel through which liquid can flow or be contained. In embodiments, a gasket is a spacer element. In embodiments, the thickness (also referred herein as the “depth” or “height” of the channel) may be altered by modulating the height of the gasket or spacer element. In embodiments, the gasket or spacer element includes a peel-off backing designed to form a sealed reaction chamber on the second solid support when adhered to the first solid support. This design ensures the creation of defined channels necessary for fluid flow and biochemical reactions within the assembled flow cell (e.g., flow cell assembly described herein). An example of a gasket or spacer element includes, but is not limited to, those used in the NovaSeq™6000 S4 flow cells, commercialized by Illumina®, which is depicted in Poovathingal et al. (doi: 10.1101/2024.02.22.581576).

Typically, the nucleic acids need to be amplified. In embodiments the term “amplified” refers to a method that includes a polymerase chain reaction (PCR). Conditions conducive to amplification (i.e., amplification conditions) are well known and often include at least a suitable polymerase, a suitable template, a suitable primer or set of primers, suitable nucleotides (e.g., dNTPs), a suitable buffer, and application of suitable annealing, hybridization and/or extension times and temperatures. Amplification conditions may cycle between different temperatures, often involving a large temperature gradient (e.g., 20° C.-40° C.). Additionally, samples embedded in formalin may require additional protocols to render biomolecules available. Heat induced epitope retrieval (HIER) uses heat coupled with buffered solutions to recover antigen reactivity in formalin fixed paraffin embedded tissue samples. Typical HIER methods include increasing the temperature from 25° C. to 95° C.-120° C., if utilizing a water bath or pressure enhanced temperature device (e.g., a pressure cooker). In embodiments, the microplate includes a microplate insert and a planar support attached to the microplate insert. In embodiments, a the planar support can include glass (e.g., a glass slide) that has been coated with a substance or otherwise modified to confer conductive properties to the glass. In some embodiments, a glass slide can be coated with a conductive coating. In some embodiments, a conductive coating includes tin oxide (TO) or indium tin oxide (ITO). In some embodiments, a conductive coating includes a transparent conductive oxide (TCO). In some embodiments, a conductive coating includes aluminum doped zinc oxide (AZO). In some embodiments, a conductive coating includes fluorine doped tin oxide (FTO).

As used herein, the term “reaction chamber” refers to a contained space or vessel designed for conducting chemical, biological, or physical reactions. A reaction chamber may include features such as inlets and outlets for introducing and removing substances, sensors for monitoring reaction conditions, and mechanisms for agitation or mixing. In embodiments, the reaction chamber is a part of the flow cell where the cell or tissue is in contact with the fluids (e.g., buffers), polymerases, nucleotides, and reagents used for the methods described herein. In embodiments, the reaction chamber is formed when a first solid support and a second solid support configured to provide a channel are attached together. In embodiments, the reaction chamber is an enclosed (i.e., closed) container containing one or two openings for introducing and removing fluids and reagents.

The term “surface” is intended to mean an external part or external layer of a substrate. The surface can be in contact with another material such as a gas, liquid, gel, polymer, organic polymer, second surface of a similar or different material, metal, or coat. The surface, or regions thereof, can be substantially flat. The substrate and/or the surface can have surface features such as wells, pits, channels, ridges, raised regions, pegs, posts or the like.

As used herein, the term “detection agent” refers to an agent with a label that is capable of specifically binding to a biomolecule of interest to facilitate the detection of the biomolecule of interest. Binding the detection agent to the biomolecule of interest facilitates detecting the label and thus, detection of the biomolecule of interest. An example of a detection agent with a label (e.g., a detectable label) include fluorescently labeled antibodies used for flow cytometry applications. An additional example of a detection agent with a label is a padlock probe capable of hybridizing to a nucleic acid of interest, where the padlock probe harbors an oligonucleotide label that is sequenced to facilitate the detection of the nucleic acid of interest.

The terms “detect” and “detecting” as used herein refer to the act of viewing (e.g., imaging, indicating the presence of, quantifying, or measuring (e.g., spectroscopic measurement), an agent based on an identifiable characteristic of the agent, for example, the light emitted from the present compounds. For example, the compound described herein can be bound to an agent, and, upon being exposed to an absorption light, will emit an emission light. The presence of an emission light can indicate the presence of the agent. Likewise, the quantification of the emitted light intensity can be used to measure the concentration of the agent.

As used herein, the term “protein-specific binding agent” refers to a molecule or agent that recognizes and binds to a protein or specific part of a protein with high affinity and specificity. Examples of a protein-specific protein binding agent include, but are not limited to, antibodies, aptamers, enzyme inhibitors, ligands for receptors, affinity tags, peptide-based protein binding agents, chelating agents for metalloproteins, and RNA interference agents. In embodiments, a protein-specific binding agent includes a protein-specific antibody conjugated to an oligonucleotide (referred herein as “protein-specific antibody-oligo (Ab-O) conjugates”), wherein the oligonucleotide in the protein-specific antibody-oligo is an oligonucleotide label as described herein.

As used herein, the term “oligonucleotide-specific binding agent” refers to a molecule (e.g., an oligonucleotide) capable of hybridizing to specific sequences of nucleotides. Examples include but are not limited to antisense oligonucleotides, aptamers, and small interfering RNA molecules.

As used herein, the term “oligonucleotide label” or “label” refers to a known nucleic acid sequence that is associated with a detection agent and that allows the target of the detection agent with which the oligonucleotide label or label is associated to be identified. In embodiments, the oligonucleotide label is a detectable label. The sequence oligonucleotide label or label is determined a priori and the identity of a biomolecule of interest (e.g., a protein or nucleic acid) is determined following the binding of the detection agent to the biomolecule of interest, detecting the sequence of the label, and associating the detection of the sequence of the label with the biomolecule of interest. In embodiments, detecting the sequence of the oligonucleotide label or label includes sequencing.

The terms “bind” and “bound” as used herein are used in accordance with their plain and ordinary meanings and refer to an association between atoms or molecules. The association can be direct or indirect. For example, bound atoms or molecules may be directly bound to one another, e.g., by a covalent bond or non-covalent bond (e.g. electrostatic interactions (e.g. ionic bond, hydrogen bond, halogen bond), van der Waals interactions (e.g. dipole-dipole, dipole-induced dipole, London dispersion), ring stacking (pi effects), hydrophobic interactions and the like). As a further example, two molecules may be bound indirectly to one another by way of direct binding to one or more intermediate molecules (e.g., as in a substrate, bound to a first antibody, bound to an analyte, bound to a second antibody), thereby forming a complex. As used herein, the term “attached” refers to the state of two things being joined, fastened, adhered, connected or bound to each other. For example, a sample such as a cell or tissue, can be attached to a material, such as a hydrogel, polymer, or solid support, by a covalent or non-covalent bond. In embodiments, attachment is a covalent attachment.

As used herein, the term “fresh,” generally in the context of a fresh tissue means that the tissue has recently been obtained from an organism, generally before any subsequent fixation steps, for example, flash freezing or chemical fixation. In embodiments, a fresh tissue is obtained from an organism about 1 second up to about 20 minutes before any fixation steps are performed. In embodiments, a fresh tissue is obtained from an organism about 1 second up to about 60 seconds before any fixation steps are performed. In embodiments, a fresh tissue is obtained from an organism about 30 seconds up to about 60 seconds before any fixation steps are performed. In embodiments, a fresh tissue is obtained from an organism about 1 minutes up to about 20 minutes before any fixation steps are performed. In embodiments, a fresh tissue is obtained from an organism about 1 minutes up to about 10 minutes before any fixation steps are performed. In embodiments, a fresh tissue is obtained from an organism about 1 minutes up to about 5 minutes before any fixation steps are performed. In embodiments, a fresh tissue is obtained from an organism about 30 seconds, about 1 minute, about 2 minutes, about 3 minutes, about 4 minutes, about 5 minutes, about 10 minutes, about 15 minutes, or about 20 minutes before any fixation steps are performed.

As used herein, the term “fix,” refers to formation of covalent bonds, such as crosslinks, between biomolecules or within molecules. The process of fixing tissue samples or biological samples (e.g., cells and nuclei) for example, is called “fixation.” The agent that causes fixation is generally referred to as a “fixative” or “fixing agent.” “Fixed biological samples” (e.g., fixed cells or nuclei) or “fixed tissues” refers to biological samples (e.g., cells or nuclei) or tissues that have been in contact with a fixative under conditions sufficient to allow or result in formation of intra- and inter-molecular crosslinks between biomolecules in the biological sample. Fixation may be reversed and the process of reversing fixation may be referred to as “un-fixing” or “decrosslinking.” Unfixing or decrosslinking refers to breaking or reversing the formation of covalent bonds in biomolecules formed by fixatives. In some examples, the tissue fixed is fresh tissue. In some examples, the tissue fixed may be frozen tissue. In some examples, the tissue fixed may not be dissociated. In some examples, the tissue fixed may be dissociated or partially dissociated (e.g., chopped, cut). In some examples, tissue that has been rapidly frozen and, perhaps, cut or chopped into pieces (e.g., small enough to fit into a tube or container used for fixation) may be used. In some examples, tissue may be dissociated or partially dissociated (e.g., cut, chopped) before or during fixation. In some examples, tissue that is fixed may not be dissociated. The frozen biological tissue can be fixed using a fixing agent, which is suitably an organic fixing agent. Suitable organic fixing agents include without limitation alcohols, ketones, aldehydes (e.g., glutaraldehyde), cross-linking agents, disuccinimidyl suberate (DSS), dimethylsuberimidate (DMS), formalin, dimethyladipimidate (DMA), dithio-bis(-succinimidyl propionate) (DSP), disuccinimidyl tartrate (DST), ethylene glycol bis(succinimidyl succinate) (EGS), bis(sulfosuccinimidyl)suberate (BS3) and combinations thereof. A particularly suitable fixing agent is a formaldehyde-based fixing agent such as formalin, which is a mixture of formaldehyde and water. The formalin may include about 1% to about 15% by weight formaldehyde and about 85% to about 99% by weight water, suitable about 2% to about 8% by weight formaldehyde and about 92% to about 98% by weight water, or about 4% by weight formaldehyde and about 96% by weight water. In some examples, tissues may be fixed in 4% paraformaldehyde. Other suitable fixing agents will be appreciated by those of ordinary skill in the art (e.g., International PCT App. No. PCT/US2020/066705, which is incorporated herein by reference in its entirety).

As used herein, the term “permeable” refers to a property of a substance that allows certain materials to pass through the substance. “Permeable” may be used to describe a biological sample, such as a cell or nucleus, in which analytes in the biological sample can leave the biological sample. “Permeabilize” is an action taken to cause, for example, a biological sample (e.g., a cell) to release its analytes. In some examples, permeabilization of a biological sample is accomplished by affecting the integrity (e.g., compromising) of a biological sample membrane (e.g., a cellular or nuclear membrane) such as by application of a protease or other enzyme capable of disturbing a membrane allowing analytes to diffuse out of the biological sample. In some embodiments, permeabilizing a biological sample does not release the biomolecules (e.g., proteins and/or nucleic acids) contained within the sample.

As used herein, the term “single biological sample”, such as a single cell or a single nucleus generally refers to a biological sample that is not present in an aggregated form or clump. Single biological samples, such as cells and/or nuclei may be the result of dissociating a tissue sample.

As used herein, the term “tissue freezing” is used in accordance with its plain and ordinary meaning and refers to different methods for freezing tissues. In some examples, the methods used may be rapid methods (e.g., “flash freezing” or “snap freezing”). In some examples, tissues may be lowered to temperatures below about −70° C. using these methods. In some examples, rapid freezing may use ultracold media. In some examples, an ultracold medium may be liquid nitrogen. In some examples, this type of freezing may preserve tissue integrity, in part by preventing the formation of ice crystals that would affect the tissue morphology. In some examples, an ultracold medium may be dry ice.

As used herein, a “single cell” refers to one cell. Single cells useful in the methods described herein can be obtained from a tissue of interest, or from a biopsy, blood sample, or cell culture. Additionally, cells from specific organs, tissues, tumors, neoplasms, or the like can be obtained and used in the methods described herein. In general, cells from any population can be used in the methods, such as a population of prokaryotic or eukaryotic organisms, including bacteria or yeast.

As used herein, the term “tissue” is used in accordance with its plain and ordinary meaning and refers to an organization of cells in a structure, where the structure generally functions as a unit in an organism (e.g., mammals) and may carry out specific functions. In some examples, cells in a tissue are configured in a mass and may not be free from one another. This disclosure describes methods of obtaining single biological samples (e.g., cells or nuclei) from tissues that can be used in various single biological samples (e.g., single-cell/nucleus) workflows. In some examples, blood cells (e.g., lymphocytes) can be considered a tissue. However, blood cells, like lymphocytes, generally are free from one another in the blood. The methods disclosed herein can be used to process those cells to obtain cells and/or nuclei, although dissociation steps may not be necessary when using those types of tissues. Generally, any type of tissue can be used in the methods described herein. Examples of tissues that may be used in the disclosed methods include, but are not limited to connective, epithelial, muscle and nervous tissue. In some examples, the tissues are from mammals. Tissues that contain any type of cells may be used. For example, tissues from abdomen, bladder, brain, esophagus, heart, intestine, kidney, liver, lung, lymph node, olfactory bulb, ovary, pancreas, skin, spleen, stomach, testicle, and the like. The tissue may be normal or tumor tissue (e.g., malignant). This example is not meant to be limiting. Although the conditions used in the disclosed may not be identical for different types of tissue, the methods may be applied to any tissue. The tissues used in the disclosed methods may be in various states. In some examples, the tissues used in the disclosed methods may be fresh, frozen, or fixed.

The term “cellular component” is used in accordance with its ordinary meaning in the art and refers to any organelle, nucleic acid, protein, or analyte that is found in a prokaryotic, eukaryotic, archaeal, or other organismic cell type. Examples of cellular components (e.g., a component of a cell) include RNA transcripts, proteins, membranes, lipids, and other analytes. In embodiments, a cellular component is a biomolecule.

As used herein, the term “kit” refers to any delivery system for delivering materials. In the context of reaction assays, such delivery systems include systems that allow for the storage, transport, or delivery of reaction reagents (e.g., oligonucleotides, enzymes, etc. in the appropriate containers) and/or supporting materials (e.g., buffers, written instructions for performing the assay, etc.) from one location to another. For example, kits include one or more enclosures (e.g., boxes) containing the relevant reaction reagents and/or supporting materials. As used herein, the term “fragmented kit” refers to a delivery system including two or more separate containers that each contain a subportion of the total kit components. The containers may be delivered to the intended recipient together or separately. For example, a first container may contain an enzyme for use in an assay, while a second container contains oligonucleotides. In contrast, a “combined kit” refers to a delivery system containing all of the components of a reaction assay in a single container (e.g., in a single box housing each of the desired components). The term “kit” includes both fragmented and combined kits.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware and systems used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In embodiments, the functions of the systems described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The term “computing device” is used herein to refer to an electronic device equipped with at least a processor. Examples of computing devices may include system or device described herein, mobile devices (e.g., cellular telephones, wearable devices, smartphones, smartwatches, web-pads, tablet computers, Internet enabled cellular telephones, Wi-Fi® enabled electronic devices, personal data assistants (PDAs), laptop computers, etc.), personal computers, and server computing devices. In various embodiments, computing devices may be configured with memory and/or storage as well as networking capabilities, such as network transceiver(s) and antenna(s) configured to establish a wide area network (WAN) connection (e.g., a cellular network connection, etc.) and/or a local area network (LAN) connection (e.g., a wired/wireless connection to the Internet via a Wi-Fi® router, etc.). In embodiments, the computing device is a mobile device, such as a cellular telephone, wearable device, or smartphone (e.g., iphone, Android, Blackberry, Palm, Symbian, or Windows).

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

As used herein, the term “feature” refers a site corresponding to a location on a solid support. A feature can contain only a single molecule or it can contain a population of several molecules of the same species (i.e., a cluster). Features of an array are typically discrete. The discrete features can be contiguous, or they can have spaces between each other. An “optically resolvable feature” refers to a feature capable of being distinguished from other features. Optics and sensor resolution has a finite limit as to a resolvable area. The Rayleigh criterion for the diffraction limit to resolution states that two images are just resolvable when the center of the diffraction pattern of one object is directly over the first minimum of the diffraction pattern of the other object. The minimal distance between two resolvable objects, r, is proportional to the wavelength of light and inversely proportional to the numerical aperture (NA). That is, the minimal distance between two resolvable objects is provided as r=0.61 wavelength/NA. If detecting light in the UV-vis spectrum (about 100 nm to about 900 nm), the remaining mutable variable to increase the resolution is the NA of the objective lens. A lens with a large NA will be able to resolve finer details. For example, a lens with larger NA is capable of detecting more light and so it produces a brighter image. Thus, a large NA lens provides more information to form a clear image, and so its resolving power will be higher. Typical dry objectives have an NA of about 0.80 to about 0.95. Higher NAs may be obtained by increasing the imaging medium refractive index between the object and the objective front lens for example immersing the lens in water (refractive index=1.33), glycerin (refractive index=1.47), or immersion oil (refractive index=1.51). Most oil immersion objectives have a maximum numerical aperture of 1.4, with the typical objectives having an NA ranging from 1.0 to 1.35.

As used herein, the term “full width at half maximum” or “FWHM” refers the width of a maximum on a line curve or line function provided by the distance between the points on the line curve corresponding to where the function reaches its half maximum.

As used herein, the term “step size” refers to the distance measured in micrometer (μm) that a focusing optical element, such as an objective lens, will move in the Z-axis between each captured image of a biological sample (e.g., a three dimensional tissue sample including cellular structures) in microscopy.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

### II. Compositions, Systems, & Kits

In an aspect is provided a non-transitory computer-readable medium storing instructions that, when executed by a processor, perform a method for analyzing a tissue sample, the method including obtaining a first image of an tissue sample using a detection apparatus; obtaining a second image of the tissue sample using the detection apparatus; identifying, by one or more processors, a first plurality of positions corresponding to a plurality of fluorescent particles in the first image, and a second plurality of positions corresponding to a plurality of fluorescent particles in the second image; and computationally determining the distance between the first image and the second image. In embodiments, computationally determining the distance includes subtracting a distance from the first plurality of positions and the second plurality of positions.

In embodiments, the non-transitory computer-readable medium is a computing device. In embodiments, the computing device is a personal computer system, server computer system, hand-held or laptop device, multiprocessor system, microprocessor-based system, set top box, programmable consumer electronic, network PC, minicomputer system, mainframe computer system, smartphone, or distributed cloud computing environments that include any of the above systems or devices. The computing device can include one or more processors or processing units, a memory architecture that may include RAM and non-volatile memory. The memory architecture may further include removable/non-removable, volatile/non-volatile computer system storage media. Further, the memory architecture may include one or more readers for reading from and writing to a non-removable, non-volatile magnetic media, such as a hard drive, a magnetic disk drive for reading from and writing to a removable, non-volatile magnetic disk, and/or an optical disk drive for reading from or writing to a removable, non-volatile optical disk such as a CD-ROM or DVD-ROM.

In an aspect is provided a solid support (e.g., a planar solid support) including a tissue section and plurality of particles as described herein, including embodiments. In embodiments, the tissue section is embedded in an embedding material, for example an embedding material including paraffin wax, polyepoxide polymer, polyacrylic polymer, agar, gelatin, celloidin, cryogel, optimal cutting temperature (OCT) composition, glycols, or a combination thereof. In embodiments, the tissue section includes a thickness of about 1 μm to about 20 μm. In embodiments, the tissue includes a thickness of about 1 μm to about 10 μm. In embodiments, the tissue includes a thickness of about 2 μm to about 3 μm. In embodiments, the tissue includes a thickness of about 4 μm to about 6 μm. In embodiments, the tissue includes a thickness of about 4 μm. In embodiments, the tissue includes a thickness of about 5 μm. In embodiments, the tissue includes a thickness of about 6 μm. In embodiments, the tissue includes a thickness of about 7 μm. In embodiments, the tissue includes a thickness of about 8 μm. In embodiments, the tissue includes a thickness of about 9 μm. In embodiments, the tissue includes a thickness of about 10 μm.

In embodiments, the tissue section includes a tissue or a cell (e.g., a plurality of cells such as blood cells). In embodiments, the tissue section includes one or more cells. In embodiments, the tissue section is embedded in an embedding material including paraffin wax, polyepoxide polymer, polyacrylic polymer, agar, gelatin, celloidin, cryogel, optimal cutting temperature (OCT) compositions, glycols, or a combination thereof. In embodiments, the tissue section is embedded in an embedding material including paraffin wax. In embodiments, the tissue section is embedded in an embedding material including a polyepoxide polymer. In embodiments, the tissue section is embedded in an embedding material including polyacrylic polymer. In embodiments, the tissue section is embedded in an embedding material including agar. In embodiments, the tissue section is embedded in an embedding material including gelatin. In embodiments, the tissue section is embedded in an embedding material including celloidin. In embodiments, the tissue section is embedded in an embedding material including a cryogel. In embodiments, the tissue section is embedded in an embedding material including an optimal cutting temperature (OCT) composition. In embodiments, the tissue section is embedded in an embedding material including one or more glycols. Tissue sections may be obtained from a subject by any means known and available in the art. In embodiments, a tissue section, e.g., a tumor tissue sample, is obtained from a subject by fine needle aspiration, core needle biopsy, stereotactic core needle biopsy, vacuum-assisted core biopsy, or surgical biopsy. In embodiments, the surgical biopsy is an incisional biopsy, which removes only part of the suspicious area.

In embodiments, the solid support includes an IR reflective coating. In embodiments, the IR reflective coating is attached to the solid support. In embodiments, the IR reflective coating is attached to the solid support, wherein the IR reflective coating is in contact with the polymer described herein. In embodiments, the IR reflective coating includes metal oxides. In embodiments, the IR reflective coating includes titanium dioxide, zinc oxide, tin oxide, tantalum pentoxide, silicon dioxide, indium tin oxide, silver-based coating, ceramic-based coating or a combination thereof. In embodiments, the IR reflective coating includes SiO₂, TiO₂, Al₂O₃ and Ta₂O₅ and fluorides such as MgF₂, LaF₃ and AlF₃. In embodiments, the IR reflective coating includes tantalum pentoxide (Ta₂O₅) and silicon dioxide (SiO₂). In embodiments, the infrared (IR) reflective coating includes one or more layers of silicon dioxide (SiO₂) and tantalum pentoxide (Ta₂O₅). In embodiments, the infrared (IR) reflective coating includes alternating layers of silicon dioxide (SiO₂) and tantalum pentoxide (Ta₂O₅), wherein the layer of silicon dioxide (SiO₂) is in direct or indirect contact with the polymer (e.g., the polymer described herein). In embodiments, the infrared (IR) reflective coating includes alternating layers of silicon dioxide (SiO₂) and tantalum pentoxide (Ta₂O₅), wherein the layer of tantalum pentoxide (Ta₂O₅) is in direct or indirect contact with the polymer (e.g., the polymer described herein).

In embodiments, the IR reflective coating reflects near-infrared radiation (NIR). In embodiments, the IR reflective coating reflects mid- or far-infrared radiation. In embodiments, the IR reflective coating reflects wavelengths greater than 750 nm. In embodiments, the IR reflective coating reflects wavelengths greater than 760 nm. In embodiments, the IR reflective coating reflects wavelengths greater than 770 nm. In embodiments, the IR reflective coating reflects wavelengths greater than 780 nm. In embodiments, the IR reflective coating reflects wavelengths greater than 790 nm. In embodiments, the IR reflective coating reflects wavelengths greater than 800 nm. In embodiments, the IR reflective coating reflects wavelengths from about 750 nm to 1,000 μm. In embodiments, the infrared (IR) reflective coating includes one or more layers of silicon dioxide (SiO₂) and tantalum pentoxide (Ta₂O₅). A multilayer configuration leverages the distinct optical properties of both materials to enhance the IR reflectivity. Silicon dioxide, known for its low refractive index, and tantalum pentoxide, recognized for its high refractive index, are alternately layered to create a stack that exhibits high reflectance in the infrared spectrum. The alternating layers of SiO₂ and Ta₂O₅ result in constructive interference of light at specific wavelengths, thereby enhancing the IR reflective capability of the coating. The number and thickness of these layers can be tailored to target specific wavelengths within the IR range, or permitting a certain percentage of radiation to transmit. For example, the IR reflective coating may reflect 2-3%, 2-6%, or 2 to 10% of the total IR radiation, and it absorbs or transmits the remaining IR radiation (e.g., greater than about 90% of the IR radiation). In embodiments, the IR reflective coating reflects about 1%, about 2%, about 3%, about 4%, about 5%, about 6%, about 7%, about 8%, about 9%, or about 10% of the total IR radiation.

In embodiments, the IR reflective coating aids autofocus mechanisms in optical instruments (e.g., fluorescence microscopy instruments) to provide consistent signal across various z-heights (e.g., the depth of an image). In embodiments, the IR reflective coating increases the amount of light reflected to the autofocus sensor to provide consistent signal across various z-heights. In embodiments, the IR reflective coating improves the signal to noise ratio of an image acquired by an optical instrument.

In embodiments, the solid support includes polymerized units of alkoxysilyl methacrylate, alkoxysilyl acrylate, alkoxysilyl methylacrylamide, alkoxysilyl acrylamide, or a copolymer thereof. In embodiments, the resist is a polydimethylsiloxane (PDMS), poly(methyl methacrylate) (PMMA), cyclic olefin copolymer (COC), silsesquioxane resist, an epoxy-based polymer resist, poly(vinylpyrrolidone-vinyl acrylic acid) copolymer resist, an Off-stoichiometry thiol-enes (OSTE) resist, amorphous fluoropolymer resist, a crystalline fluoropolymer resist, polysiloxane resist, SU-8 resist, or an organically modified ceramic polymer resist.

In embodiments, the solid support includes a photoresist. In embodiments, the solid support includes an organically modified ceramic polymer resist. In embodiments, the resist is an organically modified ceramic polymer resist. In embodiments, the organically modified ceramic polymer resist includes polymerized alkoxysilyl methacrylate polymers and metal oxides. In embodiments, the organically modified ceramic polymer resist includes polymerized alkoxysilyl acrylate polymers and metal oxides. In embodiments, the solid support includes polymerized units of alkoxysilyl methacrylate. In embodiments, the polymer layer includes polymerized units of alkoxysilyl acrylate. In embodiments, the polymer layer includes polymerized units of alkoxysilyl methylacrylamide. In embodiments, the polymer layer includes polymerized units of alkoxysilyl methylacrylamide. In embodiments, the polymer layer includes glycidyloxypropyl-trimethyloxysilane. In embodiments, the polymer layer includes methacryloxypropyl-trimethoxysilane. In embodiments, the polymer layer includes polymerized units of

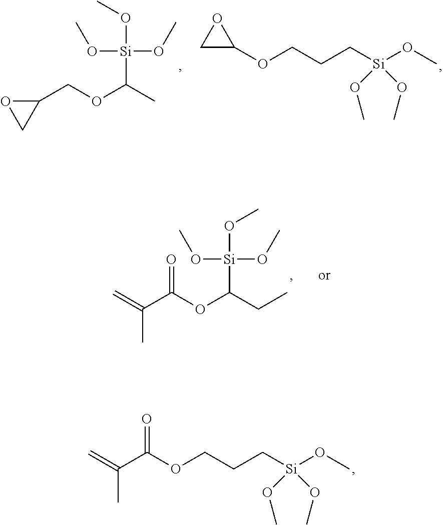

or a copolymer thereof.

The photoresist (alternatively referred to as a resist) is an active material layer that can be patterned by selective exposure and must “resist” chemical/physical attach of the underlying substrate. A photoresist is a light-sensitive polymer material used to form a patterned coating on a surface. The process begins by coating a substrate (e.g., a glass substrate) with a light-sensitive organic material. A mask with the desired pattern is used to block light so that only unmasked regions of the material will be exposed to light. In the case of a positive photoresist, the photosensitive material is degraded by light and a suitable solvent will dissolve away the regions that were exposed to light, leaving behind a coating where the mask was placed. In the case of a negative photoresist, the photosensitive material is strengthened (either polymerized or cross-linked) by light, and a suitable solvent will dissolve away only the regions that were not exposed to light, leaving behind a coating in areas where the mask was not placed. In embodiments, the solid support includes an epoxy-based photoresist (e.g., SU-8, SU-8 2000, SU-8 3000, SU-8 GLM2060). In embodiments, the solid support includes a negative photoresist. Negative refers to a photoresist whereby the parts exposed to UV become cross-linked (i.e., immobilized), while the remainder of the polymer remains soluble and can be washed away during development.

In embodiments, the solid support includes a glass substrate having a surface coated in silsesquioxane resist (e.g., polyhedral oligosilsesquioxanemethacrylate (POSS)), an epoxy-based polymer resist (e.g., SU-8 as described in U.S. Pat. No. 4,882,245), poly(vinylpyrrolidone-vinyl acrylic acid) copolymer resist (e.g., as described in U.S. Pat. No. 7,467,632), or novolaks resist, bisazides resist, or a combination thereof (e.g., as described in U.S. Pat. No. 4,970,276). In embodiments, the resist is removed prior to loading.

A “resist” as used herein is used in accordance with its ordinary meaning in the art of lilthography and refers to a polymer matrix (e.g., a polymer network). In embodiments, the photoresist is a silsesquioxane resist. In embodiments, the photoresist is an epoxy-based polymer resist. In embodiments, the photoresist is a poly(vinylpyrrolidone-vinyl acrylic acid) copolymer resist. In embodiments, the photoresist is an Off-stoichiometry thiol-enes (OSTE) resist. In embodiments, the solid support includes a Hydrogen Silsesquioxane (HSQ) polymer (e.g., HSQ resist). In embodiments, the photoresist is an amorphous fluoropolymer resist. In embodiments, the photoresist is a crystalline fluoropolymer resist. In embodiments, the photoresist is a polysiloxane resist. In embodiments, the photoresist is an organically modified ceramic polymer resist. In embodiments, the photoresist includes polymerized alkoxysilyl methacrylate polymers and metal oxides (e.g., SiO₂, ZrO, MgO, Al₂O₃, TiO₂ or Ta₂O₅). In embodiments, the photoresist includes polymerized alkoxysilyl acrylate polymers and metal oxides (e.g., SiO₂, ZrO, MgO, Al₂O₃, TiO₂ or Ta₂O₅). In embodiments, the photoresist includes metal atoms, such as Si, Zr, Mg, Al, Ti or Ta atoms.

In embodiments, the solid support includes a resist (e.g., a nanoimprint lithography (NIL) resist). Nanoimprint resists can include thermal curable materials (e.g., thermoplastic polymers), and/or UV-curable polymers. In embodiments, the solid support is generated by pressing a transparent mold possessing the pattern of interest (e.g., the pattern of wells) into photo-curable liquid film, followed by solidifying the liquid materials via a UV light irradiation. Typical UV-curable resists have low viscosity, low surface tension, and suitable adhesion to the glass substrate. For example, the solid support surface is coated in an organically modified ceramic polymer (ORMOCER®, registered trademark of Fraunhofer-Gesellschaft zur Förderung der angewandten Forschung e. V. in Germany). Organically modified ceramics contain organic side chains attached to an inorganic siloxane backbone. Several ORMOCER® polymers are now provided under names such as “Ormocore”, “Ormoclad” and “Ormocomp” by Micro Resist Technology GmbH. In embodiments, the solid support includes a resist as described in Haas et al Volume 351, Issues 1-2, 30 Aug. 1999, Pages 198-203, US 2015/0079351A1, US 2008/0000373, US 2010/0160478, or U.S. Pat. No. 10,268,096 B2, each of which is incorporated herein by reference. In embodiments, the solid support surface is coated in an organically modified ceramic polymer including (ORMOCER®, registered trademark of Fraunhofer-Gesellschaft zur Förderung der angewandten Forschung e. V. in Germany). In embodiments, the solid support surface is coated in an organically modified ceramic polymer wherein the organically modified ceramic polymer includes an inorganic-organic hybrid polymer that includes Si—O bonds. In embodiments, the solid support surface is coated in an organically modified ceramic polymer wherein the organically modified ceramic polymer includes an inorganic-organic hybrid polymer that includes Si—C bonds. In embodiments, the solid support surface is coated in an organically modified ceramic polymer wherein the organically modified ceramic polymer includes free acrylate moieties. In embodiments, the polymer is an organically modified ceramic polymer wherein the organically modified ceramic polymer includes an inorganic-organic hybrid polymer that includes Si—O bonds. In embodiments, polymer is an organically modified ceramic polymer wherein the organically modified ceramic polymer includes an inorganic-organic hybrid polymer that includes Si—C bonds. In embodiments, the polymer is an organically modified ceramic polymer wherein the organically modified ceramic polymer includes free acrylate moieties. In embodiments, the polymer contains organically crosslinked heteropolysiloxane moieties.

In some embodiments, the solid support includes a hydrophobic polymer layer. In embodiments, the solid support includes a perfluorinated polymer. In embodiments, the solid support includes a polyfluorinated polymer. In embodiments, the solid support includes polymerized units of a fluorine-containing methacrylate (e.g., CH₂═C(CH₃)COOC—(CF₃)₂CF₂CF₂CF₃). Non-limiting examples and synthetic protocols of fluorine-containing methacrylate monomers may be found in Zhang, D., (2018). Materials (Basel, Switzerland), 11(11), 2258 (2018), which is incorporated herein by reference. In embodiments, the fluorinated polymer is an amorphous (non-crystalline) fluoropolymer (e.g., CYTOP® from Bellex), a crystalline fluoropolymer, or a fluoropolymer having both amorphous and crystalline domains.

In embodiments, the first solid support includes a refractive index of about 1.5. In embodiments, the first solid support includes a refractive index of about 1.52. In embodiments, the first solid support includes a refractive index of about 1.524 to about 1.527. In embodiments, the second solid support includes a refractive index of about 1.5. In embodiments, the second solid support includes a refractive index of about 1.52. In embodiments, the second solid support includes a refractive index of about 1.524 to about 1.527.

In embodiments, the first solid support includes drilled ports. In embodiments, the second solid support includes drilled ports. In embodiments, the second solid support includes a channel bored into the second solid support. In embodiments, the second solid support includes a gasket, wherein the gasket defines the reaction chamber. In embodiments, the second solid support includes 2, 3, 4, 5, 6, 7, 8, 9, 10, 11, or 12 reaction chambers. In embodiments, the first solid support includes an inlet port and an outlet port. In embodiments, the second solid support includes an inlet port and an outlet port.

In yet another aspect is provided a system for analyzing a tissue sample, the system comprising: (a) a memory storing instructions; (b) a processor configured to execute the instructions to: obtain a first image of an tissue sample using a detection apparatus; obtain a second image of the tissue sample using the detection apparatus; identify, by one or more processors, a first plurality of positions corresponding to a plurality of fluorescent particles in the first image, and a second plurality of positions corresponding to a plurality of fluorescent particles in the second image; and compute a distance between the first image and second image.

In embodiments, the system includes one or more processing units CPU(s) (also referred to as processors), one or more network interfaces, a user interface including a display and an input module, a non-persistent, a persistent memory, and one or more communication buses for interconnecting these components. The one or more communication buses optionally include circuitry (sometimes called a chipset) that interconnects and controls communications between system components. The non-persistent memory typically includes high-speed random access memory, such as DRAM, SRAM, DDR RAM, ROM, EEPROM, flash memory, whereas the persistent memory typically includes CD-ROM, digital versatile disks (DVD) or other optical storage, magnetic cassettes, magnetic tape, magnetic disk storage or other magnetic storage devices, magnetic disk storage devices, optical disk storage devices, flash memory devices, or other non-volatile solid state storage devices. The persistent memory optionally includes one or more storage devices remotely located from the CPU(s). The persistent memory, and the non-volatile memory device(s) within the non-persistent memory, comprise non-transitory computer readable storage medium. In embodiments, one or more of the above identified elements are stored in one or more of the previously mentioned memory devices, and correspond to a set of instructions for performing a function described above. The above identified modules, data, or programs (e.g., sets of instructions) need not be implemented as separate software programs, procedures, datasets, or modules, and thus various subsets of these modules and data may be combined or otherwise re-arranged in various implementations.

In embodiments, the computing device includes memory in electronic communication with the processor. The memory architecture may include at least one program module implemented as executable instructions that are configured to carry out one or more steps of a method set forth herein. For example, executable instructions may include an operating system, one or more application programs, other program modules, and program data. Generally, program modules may include routines, programs, objects, components, logic, and data structures that perform particular tasks. A computing device can optionally communicate with one or more external devices such as a keyboard, a pointing device (e.g., a mouse), a display, such as a graphical user interface (GUI), or other device that facilitates interaction of a use with the unmanned autonomous vehicle. Similarly, the computing device can communicate with other devices (e.g., via network card, modem, etc.). Such communication can occur via I/O interfaces. In embodiments, the computing system may communicate with one or more networks such as a local area network (LAN), a general wide area network (WAN), and/or a public network (e.g., the Internet) via a suitable network adapter.

In embodiments, the systems and devices generate data that may be used to form an image. In embodiments, the image includes a 2D or 3D representation of the tissue. In some embodiments, one or more of the images include an image of other analytes, such as proteins in a biological sample. In some embodiments, an image is acquired using transmission light microscopy (e.g., bright field transmission light microscopy, dark field transmission light microscopy, oblique illumination transmission light microscopy, dispersion staining transmission light microscopy, phase contrast transmission light microscopy, differential interference contrast transmission light microscopy, emission imaging, etc.). In embodiments, the image is in any file format including but not limited to JPEG/JFIF, TIFF, Exif, PDF, EPS, GIF, BMP, PNG, PPM, PGM, PBM, PNM, WebP, HDR raster formats, HEIF, BAT, BPG, DEEP, DRW, ECW, FITS, FLIF, ICO, ILBM, IMG, PAM, PCX, PGF, JPEG XR, Layered Image File Format, PLBM, SGI, SID, CDS, CPT, PSD, PSP, XCF, PDN, CGM, SVG, PostScript, PCT, WMF, EMF, SWF, XAML, and/or RAW. In embodiments, the image is represented as an array (e.g., matrix) comprising a plurality of pixels, such that the location of each respective pixel in the plurality of pixels in the array (e.g., matrix) corresponds to its original location in the image. In some embodiments, an image is represented as a vector comprising a plurality of pixels, such that each respective pixel in the plurality of pixels in the vector comprises spatial information corresponding to its original location in the image.

In embodiments, a pixel includes one or more pixel values (e.g., intensity value). In embodiments, each respective pixel in the plurality of pixels includes one pixel intensity value, such that the plurality of pixels represents a single-channel image comprising a one-dimensional integer vector comprising the respective pixel values for each respective pixel. For example, an 8-bit single-channel image (e.g., grey-scale) can include 2⁸ or 256 different pixel values (e.g., 0-255). In embodiments, each respective pixel in the plurality of pixels of an image includes a plurality of pixel values, such that the plurality of pixels represents a multi-channel image comprising a multi-dimensional integer vector, where each vector element represents a plurality of pixel values for each respective pixel. For example, a 24-bit 3-channel image (e.g., RGB color) can include 2²⁴ (e.g., 2⁸⁻³) different pixel values, where each vector element comprises 3 components, each between 0-255. In some embodiments, an n-bit image includes up to 2ⁿ different pixel values, where n is any positive integer.

In embodiments, each pixel in the plurality of pixels of the image has a pixel size (resolution) between 0.8 pm and 4.0 pm. In embodiments the pixel size is derived by dividing the camera pixel size (resolution) by the magnification of the objective lens of the camera used to capture values for the plurality of pixels. In embodiments, each pixel in the plurality of pixels has a pixel size between 0.4 pm and 5.0 pm. In embodiments, each pixel in the plurality of pixels of the image has a pixel size (resolution) between 0.8 pm and 4.0 pm or between 0.4 pm and 5.0 pm.

In embodiments, the data processor provides the image for display via a display of the computing device. In embodiments, the image is provided for display via a GUI configured within the display of the computing device. In embodiments, the data processor receives an input identifying one or more modifications and/or one or more image analysis steps based on the provided image. For example, the display of the computing device can include a touchscreen display configured to receive a user input identifying a respective pattern of an image of the biological sample on the displayed image. In embodiments, the GUI can be configured to receive a user provided input identifying the modifications and/or one or more image analysis steps.

Methods as described herein can be implemented by way of machine (e.g., computer processor) executable code stored on an electronic storage location of the computer system, such as, for example, on the memory or electronic storage unit. The machine executable or machine readable code can be provided in the form of software. During use, the code can be executed by the processor. In some cases, the code can be retrieved from the storage unit and stored on the memory for ready access by the processor. In some situations, the electronic storage unit can be precluded, and machine-executable instructions are stored on memory.

The code can be pre-compiled and configured for use with a machine having a processor adapted to execute the code, or can be compiled during runtime. The code can be supplied in a programming language that can be selected to enable the code to execute in a pre compiled or as-compiled fashion.

Examples of the systems and methods provided herein, such as the computer system 501, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk.

“Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media (e.g., computer-readable media) include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system can include or be in communication with an electronic display that comprises a user interface (UI) for tissue sample analysis. Examples of UIs include, without limitation, a graphical user interface (GUI) and web-based user interface. Methods and systems of the present disclosure can be implemented by way of one or more algorithms. An algorithm can be implemented by way of software upon execution by the central processing unit.

According to certain embodiments, the above-described data feeds may be stored in databases such as database servers that store master data as well as logging and trace information. The databases may also provide an API and/or API access (e.g., for open source) to the web server for data interchange based on JSON specifications. According to certain embodiments, the database servers may be optimally designed for storing large amounts of data, responding quickly to incoming requests, having a high availability and historizing master data.

The system contemplates uses in association with web services, utility computing, pervasive and individualized computing, security and identity solutions, autonomic computing, cloud computing, commodity computing, mobility and wireless solutions, open source, biometrics, grid computing, and/or mesh computing.

In an aspect is provided a flow cell assembly. In embodiments, the flow cell assembly includes a first solid support; a polymer attached to the first solid support; a cell or tissue attached to the polymer; a second solid support attached to the first solid support, wherein the second solid support is configured to define a reaction chamber. In embodiments, the second solid support is configured to define a reaction chamber when attached to the first solid support. In embodiments, the flow cell assembly includes a frame configured to retain the flow cell assembly. Suitable flow cell frames and handles are described in U.S. Pat. No. 11,747,262. The frame can be configured to retain the flow cell such that a maximal surface area of the flow cell can be available to be exposed to an optical lens (e.g., the optical lens of a nucleic acid sequencing device). The optical lens (e.g., the optical lens of the sequencing device) can be configured to detect excitation, emission, or other signals present on the flow cell. The frame can be configured to retain the flow cell such that a maximal surface area of the flow cell can be available to be in contact with the receiver of a nucleic acid sequencer. The retaining of the flow cell further can include constraining a first, a second, a third, a fourth, a fifth, and a sixth degree of freedom of the flow cell. The frame can be an injection molded frame. The handle can be a raised handle. The frame can be further configured to provide a gap between a work surface and the flow cell. The frame further can include at least one ferromagnetic pin. The at least one biasing feature can be a spring finger. The at least one biasing feature can be a tab. The flow cell can further include a microchip. The microchip can be an electronically erasable programmable read only memory (EEPROM) chip. Flow cells provide a convenient format for housing an array of clusters produced by the methods described herein, in particular when subjected to an SBS or other detection technique that involves repeated delivery of reagents in cycles.

In embodiments, the first solid support includes one or more channel(s). In embodiments, the first solid support includes a channel bored into the first solid support. In embodiments, the first solid support includes a plurality of channels bored into the first solid support. In embodiments, the first solid support includes 2 channels bored into the first solid support. In embodiments, the first solid support includes 3 channels bored into the first solid support. In embodiments, the first solid support includes 4 channels bored into the first solid support. In embodiments, the width of the channel is from about 1 to 5 mm. In embodiments, the width of the channel is from about 5 to 10 mm. In embodiments, the width of the channel is from about 10 to 15 mm. In embodiments, the width of the channel is from about 5 mm. In embodiments, the width of the channel is from about 11 mm. In embodiments, the second solid support includes one or more channel(s). In embodiments, the second solid support includes a channel bored into the second solid support. In embodiments, the second solid support includes a plurality of channels bored into the second solid support. In embodiments, the second solid support includes 2 channels bored into the second solid support. In embodiments, the second solid support includes 3 channels bored into the second solid support. In embodiments, the second solid support includes 4 channels bored into the second solid support. In embodiments, the width of the channel is from about 1 to 5 mm. In embodiments, the width of the channel is from about 5 to 10 mm. In embodiments, the width of the channel is from about 10 to 15 mm. In embodiments, the width of the channel is from about 5 mm. In embodiments, the width of the channel is from about 11 mm.

In embodiments, the second solid support includes a gasket (alternatively referred to herein as a spacer), wherein the gasket defines the reaction chamber. In embodiments, the gasket defines a perimeter of a channel. In embodiments, the gasket includes silicone, polyimide, fluorocarbon elastomer, ethylene propylene diene, polychloroprene, polytetrafluoroethylene, nitrile rubber, butyl rubber, natural rubber, thermoplastic elastomer, or a combination thereof. In embodiments, the second solid support includes a spacer element to form an offset surface. In embodiments, the second solid support includes one or more channels. The channel(s) may be formed by affixing a spacer element to create a defined gap or channel through which liquid can flow or be contained. The spacer element may be made of any suitable material, for example resin, glass, plastic, silicon, an adhesive, or a combination thereof. In embodiments, the spacer element includes a first adhesive in contact with the functionalized glass slide and second adhesive in contact with the second solid support. In embodiments, the spacer element includes a first adhesive in contact with the functionalized glass slide, a second adhesive in contact with the second solid support, and a carrier material in contact with the first adhesive and the second adhesive. The depth of the resulting channel may be controlled by including a carrier material (e.g., one or more polymer or copolymer layers) between the adhesives. In embodiments, the spacer element may form the walls of the reaction chamber, wherein the reaction chamber includes the sample. In embodiments, the spacer element is further attached to the copolymer attached the polymer of the first solid support. In embodiments, the gasket is referred to as a spacer element.

In embodiments, the flow cell assembly further includes 2, 3, 4, 5, 6, 7, 8, 9, 10, 11, or 12 reaction chambers (e.g., channels). In embodiments, the flow cell assembly includes 2 distinct reaction chambers (e.g., channels). In embodiments, the flow cell assembly includes 4 distinct reaction chambers (e.g., channels). In embodiments, each reaction chamber includes a depth of about 50 μm to about 150 μm. In embodiments, the reaction chamber includes a depth of about 80 μm to about 110 μm. In embodiments, the reaction chamber includes a width of about 4 μm to about 15 μm.

In an aspect is provided a kit, including a plurality of particles as described herein. In embodiments, the kit includes a solid support or flow cell assembly as described herein. In an aspect is provided a kit, including the first solid support attached to a polymer, which is further attached to an IR reflective coating, coating agent, and/or particles; a copolymer attached to the polymer, and a second solid support, configured to define a reaction chamber when attached to the first solid support. Generally, the kit includes one or more containers providing a composition and one or more additional reagents (e.g., a buffer suitable for polynucleotide extension). The kit may also include a template nucleic acid (DNA and/or RNA), one or more primer polynucleotides, nucleoside triphosphates (including, e.g., deoxyribonucleotides, ribonucleotides, particles, polymerases, labeled nucleotides, and/or modified nucleotides), buffers, salts, and/or labels (e.g., fluorophores). In embodiments, the kit includes a plurality of detection agents capable of detecting a biomolecule (or plurality thereof) from a tissue section. In embodiments, the kit includes the tissue section including the biomolecule to be detected (or plurality thereof) already immobilized onto the first solid support of the flow cell assembly as described herein. In embodiments, kit includes the flow cell assembly as described herein and a flow cell carrier (e.g., a flow cell carrier as described in U.S. Pat. No. 11,747,262, which is incorporated herein by reference for all purposes). Generally, the kit includes one or more containers providing a composition and one or more additional reagents (e.g., a buffer suitable for polynucleotide extension). The kit may also include a template nucleic acid (DNA and/or RNA), one or more primer polynucleotides, nucleoside triphosphates (including, e.g., deoxyribonucleotides, ribonucleotides, particles, labeled nucleotides, and/or modified nucleotides), buffers, salts, and/or labels (e.g., fluorophores). In embodiments, the kit includes an array with particles already loaded into the wells. In embodiments, the particles are in a container. In embodiments, the particles are in aqueous suspension or as a powder within the container. The container may be a storage device or other readily usable vessel capable of storing and protecting the particles. The kit may also include a flow cell. The term “kit” includes both fragmented and combined kits. In embodiments, the kit includes, without limitation, nucleic acid primers, probes, adapters, enzymes, and the like, and are each packaged in a container, such as, without limitation, a vial, tube or bottle, in a package suitable for commercial distribution, such as, without limitation, a box, a sealed pouch, a blister pack and a carton. The package typically contains a label or packaging insert indicating the uses of the packaged materials. As used herein, “packaging materials” includes any article used in the packaging for distribution of reagents in a kit, including without limitation containers, vials, tubes, bottles, pouches, blister packaging, labels, tags, instruction sheets and package inserts.

### III. Methods

In an aspect is a method of measuring a tissue sample attached to a first solid support, the method including: distributing a first plurality of fluorescent particles across a first surface of a first solid support; adhering a tissue sample to the first solid support; attaching a second solid support to the first solid support; introducing a solution to the second solid support wherein solution includes a second plurality of fluorescent particles that adhere to an exposed region of the tissue sample; and acquiring images of the first plurality of fluorescent particles and the second plurality of fluorescent particles across a cross section of the tissue sample. In embodiments, the method includes iteratively acquiring images across a plurality of cross sections. In embodiments, the method includes determining the thickness of the tissue sample.

In embodiments, the method includes computationally determining the variance of the Laplacian Operator. To enhance accuracy, the method may also include computationally determining the variance of the Laplacian operator applied to each acquired image. By applying the Laplacian operator to each region of interest (ROI) within an image, edge information is emphasized, revealing sharp boundaries where fluorescent particles reside. Calculating the variance of the Laplacian output in these regions helps quantify particle positioning through the tissue depth, providing a precise method for measuring tissue thickness and accurately defining particle locations. This variance serves as a metric to estimate distances between layers in the tissue, further refining measurements of the tissue sample's structural features. In embodiments, the Brenner contrast metric may be used.

In embodiments, the method includes immobilizing a plurality of tissue sections to the first solid support, wherein a tissue in a plurality of tissue sections includes the biomolecule to be detected. In embodiments, the method includes immobilizing 24 tissue sections (10 mm×17 mm sections). In embodiments, the method includes immobilizing 40 tissue sections (10 mm×10 mm sections). In embodiments, the method includes immobilizing 128 tissue sections (4 mm×4 mm sections).

The cell or tissue may be manipulated prior to immobilizing the cell or tissue onto a solid support using known techniques in the art (see, e.g., PCT Publication WO2023076832A1). In embodiments, the method further includes cutting a sample portion from the biological sample (e.g., including cells or tissues) using a punch device such that the punch device contains the sample portion; mounting the punch device containing the sample portion onto the first solid support as described herein (e.g., inverting the punch device); pushing the sample portion out of the punch device using a piston, so that all or a portion thereof of the sample portion is positioned on the first solid support as described herein. In embodiments, the method further includes cutting a sample portion from the biological sample using two or more punch devices such that each punch device contains a different the sample portion; mounting each punch device containing the sample portion onto the first solid support as described herein; pushing the sample portions out of the punch devices using one or more pistons so that the sample portions are positioned onto the first solid support as described herein.

In embodiments, the method includes obtaining an image of the tissue sample. The imaging step may be performed with high-resolution techniques, such as fluorescence microscopy, which captures emitted signals from fluorescent particles introduced to specific surfaces of the tissue sample. In embodiments, and to ensure comprehensive visualization, images may be taken across multiple focal planes or cross-sections along the z-axis of the tissue, capturing features at various depths to enable identification of key structures and interfaces. Imaging parameters, including exposure time, gain settings, and focal depth, may be adjusted to optimize contrast and resolution, contributing to the clarity and precision of each acquired image. Obtaining detailed images allows for accurate localization of fluorescent particles relative to the tissue layers and supports subsequent computational analyses. These analyses may include edge detection via the Laplacian operator and variance calculations, instrumental in distinguishing boundaries and measuring distances within the tissue. The imaging process thereby provides a critical foundation for assessing the structural integrity, thickness, and spatial relationships among regions of interest within the tissue sample.

In embodiments, the method includes contacting the first solid support with a first fluorescent particle. In embodiments, the fluorescent particle includes a particle core and a shell polymer, wherein the shell polymer includes a first fluorophore moiety covalently attached to the shell polymer and a second fluorophore moiety covalently attached to the shell polymer. In embodiments, the first fluorophore moiety and the second fluorophore moiety are spectrally distinct. In embodiments, the shell polymer surrounds the particle core. In embodiments, the particle core includes silica, glass, ceramic, metal, magnetic material, or a paramagnetic material. In embodiments, the particle core includes silica, a magnetic bead, or a paramagnetic bead. The particle core may be an inorganic particle core. The inorganic particle core may be a metal particle core. When the particle core is a metal, the metal may be titanium, zirconium, gold, silver, platinum, cerium, arsenic, iron, aluminum or silicon. The metal particle core may be titanium, zirconium, gold, silver, or platinum and appropriate metal oxides thereof. In embodiments, the particle core is titanium oxide, zirconium oxide, cerium oxide, arsenic oxide, iron oxide, aluminum oxide, or silicon oxide. The metal oxide particle core may be titanium oxide or zirconium oxide. The particle may be titanium. The particle may be gold. The particle may be silicon dioxide. The particle may be silica. In embodiments, the particle core is in the form of a bead. For example, the core/shell layers may be formed around a supporting structure, for example, a silica, magnetic, or paramagnetic bead. In some embodiments, the composition includes a solid bead support (which itself may include a magnetic core and an encapsulating polymer layer), a functional core layer around the bead for primer attachment, and a shell polymer layer in which no amplification reactions take place. In embodiments, the particle is a silica particle includes a magnetic core, and a copolymer shell. In embodiments, the particle shell is chemically distinct from the particle core.

In embodiments, the average longest dimension of the particle is from about 150 nm to about 1,000 nm. In embodiments, the average longest dimension of the particle is from about 250 nm to about 500 nm. In embodiments, the average longest dimension of the particle is from about 100 nm to about 3000 nm. In embodiments, the average longest dimension of the particle is from about 200 nm to about 2900 nm. In embodiments, the average longest dimension of the particle is from about 300 nm to about 2800 nm. In embodiments, the average longest dimension of the particle is from about 400 nm to about 2700 nm. In embodiments, the average longest dimension of the particle is from about 500 nm to about 2600 nm. In embodiments, the average longest dimension of the particle is from about 600 nm to about 2500 nm. In embodiments, the average longest dimension of the particle is from about 700 nm to about 2400 nm. In embodiments, the average longest dimension of the particle is from about 800 nm to about 2300 nm. In embodiments, the average longest dimension of the particle is from about 900 nm to about 2200 nm. In embodiments, the average longest dimension of the particle is from about 1000 nm to about 2100 nm. In embodiments, the average longest dimension of the particle is from about 900 nm to about 2000 nm. In embodiments, the average longest dimension of the particle is from about 150 nm to about 600 nm. In some embodiments, the average longest dimension of the particle is from about 350 nm to about 600 nm. In some embodiments, the average longest dimension of the particle is from about 400 nm to about 500 nm. In some embodiments, the average longest dimension of the particle is about 500 nm. In some embodiments, the average longest dimension of the particle is about 400 nm. In some embodiments, the average longest dimension of the particle is about 400 nm, 450 nm, 500 nm, or 550 nm. In some embodiments, the average longest dimension of the particle is about 410 nm, 420 nm, 430 nm, 440 nm or 450 nm. In some embodiments, the average longest dimension of the particle is about 460 nm, 470 nm, 480 nm, 490 nm or 500 nm. In embodiments, the average longest dimension of the particle is at least, about, or at most 100, 200, 300, 400, 500, 600, 700, 800, 900, 1000 nm or a number or a range between any two of these values. In embodiments, the particle shell diameter is at least, about, or at most 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4., 4.5, 4.6, 4.7, 4.8, 4.9, 5.0 μm or a number or a range between any two of these values. In embodiments, the core diameter is about 150-700 nanometers, and/or the shell diameter is about 0.25-5 μm (microns).

In embodiments, the first fluorophore moiety emits in a first wavelength range and the second fluorophore moiety emits in a second distinct wavelength range. In embodiments, the maximum excitation wavelength is between 350-400 nm, between 400-450 nm, between 450-500 nm, between 500-550 nm, between 550-600 nm, between 600-650 nm, between 650-700 nm, or between 700-750 nm. In embodiments, the maximum emission wavelength is between 400-450 nm, between 450-500 nm, between 500-550 nm, between 550-600 nm, between 600-650 nm, between 650-700 nm, between 700-750 nm, between 750-800 nm, or between 800-850 nm.

In embodiments, the particle is configured for use in multi-channel fluorescence imaging for calibration or focus adjustment. In embodiments, the particles aid calibration of optical instruments used herein (e.g., fluorescence microscopy instruments). In embodiments, the particles used herein emit fluorescence at known wavelengths, which aids the calibration of fluorescence detection channels on optical instruments used herein. In embodiments, the particles used herein aids the testing the image quality and spatial resolution across different z-heights (e.g., depth of an image acquired of a tissue section described herein).

In embodiments, the first and second fluorophore moieties are homogeneously distributed throughout the shell polymer.

In embodiments, the images of the first plurality of fluorescent particles and the second plurality of fluorescent particles are acquired using an objective lens that moves along a z axis at defined steps focused on the first plurality of fluorescent particles. In embodiments, the images of the first plurality of fluorescent particles and the second plurality of fluorescent particles are acquired using an objective lens that moves along a z axis at defined steps focused on the second plurality of fluorescent particles. In embodiments, the images of the first plurality of fluorescent particles and the second plurality of fluorescent particles are acquired using an objective lens that moves along a z axis at defined steps focused on the first plurality of fluorescent particles and the second plurality of fluorescent particles.

In embodiments, the images are acquired across an entire cross section of the tissue sample and across an entire surface area of the tissue sample.

In embodiments, introducing a solution to the second solid support includes flowing a solution through at least one channel of the second solid support. In embodiments, the solution is introduced into the at least one channel via at least one port of the second solid support.

In embodiments, the solution includes a plurality of the second fluorescent particle. In embodiments, the solution includes an alcohol, where the concentration of alcohol (v/v) is about 90%, about 91%, about 92%, about 93%, about 94%, about 95%, about 96%, about 97%, about 98%, or about 99% alcohol. In embodiments, the alcohol is ethanol, propanol, isopropanol, methanol, or butanol. In embodiments, the alcohol is ethanol. In embodiments, the alcohol is butanol.

In embodiments, the first plurality of fluorescent particles may attach to the tissue sample through various mechanisms that facilitate stable adherence. Non-limiting examples include covalent bonding, electrostatic interactions, or affinity binding. Covalent bonding can be achieved by functionalizing the particle surfaces with reactive groups that form stable bonds with complementary groups on the tissue surface. For instance, amine-reactive groups on the particles may bind to exposed carboxyl groups within the tissue. Alternatively, electrostatic interactions may provide a mechanism for attachment, where particles with a positive or negative charge adhere to oppositely charged regions on the tissue. In another example, affinity binding may be employed, where particles are functionalized with molecules that specifically bind to tissue components, such as antibodies targeting specific antigens present on the tissue. This selective approach allows for precise localization of particles to regions of interest within the tissue sample, facilitating accurate imaging and analysis.

In embodiments, the first solid support is a sample slide. In embodiments, adhering a tissue sample to the first solid support includes adhering the tissue sample to a resist (e.g., a resist as described herein) positioned on the first surface of the first solid support.

In embodiments, the first plurality of fluorescent particles may include focusing beads, which provide stable and precise reference points across the tissue sample to facilitate image alignment and depth calibration. Focusing beads are typically composed of photostable materials, ensuring they emit consistent fluorescence signals under extended imaging conditions. These beads may be engineered to a defined size and shape, allowing for predictable interaction with imaging equipment and reducing variability in focus across multiple images or focal planes. In embodiments, focusing beads are designed to have a specific emission wavelength that can be easily distinguished from other fluorescent markers within the tissue, enabling spectral separation that minimizes signal overlap. Additionally, focusing beads may be coated with functional groups, such as amine or carboxyl groups, which enable selective attachment to designated regions within the tissue sample, ensuring consistent positioning and reliable focus calibration during imaging.

In embodiments, a top of the first solid support corresponds to an interface between the tissue sample and the first solid support, and the bottom of the first solid support corresponds to an interface between tissue section and the second solid support.

In embodiments, the method includes obtaining the tissue sample by cutting a region of tissue with a cutter of a punch device such that the tissue sample is retained within the cutter. In embodiments, the method includes placing the cutter with the tissue sample onto a receiving array. In embodiments, multiple tissue samples are obtained by repeating the cutting and placing steps.

In embodiments, the method includes aligning the first solid support to the receiving array. In embodiments, the method includes adhering a tissue sample to the first solid support including using a plunger (e.g., a piston) to push the tissue sample out of the cutter onto the first solid support.

In embodiments, the method includes heating the receiving array. In embodiments, the method includes heating the plunger. In embodiments, the method includes heating the first solid support.

In embodiments, the method includes removing the removing the receiving array, and the plunger from the first solid support such that the tissue sample is retained on the first solid support.

In another aspect is provided a method of measuring a tissue section, said method including attaching a tissue section to a first solid support, wherein the first solid support includes a first fluorescent particle attached to the surface of the solid support; attaching a second fluorescent particle to the surface of the tissue section; imaging the first fluorescent particle at a first depth and imaging the second fluorescent particle at a second depth using a detection apparatus; and determining the difference (e.g., computationally subtracting) the first depth from the second depth, thereby measuring the thickness of the tissue section. In embodiments, the method includes attaching a second solid support to the first solid support. In embodiments, the second solid support includes a channel bored into the second solid support. In embodiments, the second solid support is configured to define a reaction chamber when attached to the first solid support. In embodiments, the second solid support defines a reaction chamber when attached to the first solid support. In embodiments, the second solid support includes a gasket, wherein the gasket defines the reaction chamber.

In embodiments, the tissue is embedded in an embedding material including paraffin wax, polyepoxide polymer, polyacrylic polymer, agar, gelatin, celloidin, cryogel, optimal cutting temperature (OCT) compositions, glycols, or a combination thereof. In embodiments, the tissue is embedded in an embedding material that includes paraffin wax. In embodiments, the tissue is embedded in an embedding material that includes a polyepoxide polymer. In embodiments, the tissue is embedded in an embedding material that includes a polyacrylic polymer. In embodiments, the tissue is embedded in an embedding material that includes agar. In embodiments, the tissue is embedded in an embedding material that includes gelatin. In embodiments, the tissue is embedded in an embedding material that includes celloidin. In embodiments, the tissue is embedded in an embedding material that includes cryogel. In embodiments, the tissue is embedded in an embedding material that includes optimal cutting temperature (OCT) compositions. In embodiments, the tissue is embedded in an embedding material that includes glycols. In embodiments, the tissue is embedded in an embedding material that includes a combination of the aforementioned materials.

In embodiments, the solid support includes a plurality of the first fluorescent particles. In embodiments, the first fluorescent particle includes one or more fluorescent moieties. In embodiments, the first fluorescent particle includes a first fluorescent moiety and a second fluorescent moiety. In embodiments, the first fluorescent moiety emits in a first wavelength range and the second fluorescent moiety emits in a second distinct wavelength range.

In embodiments, the second fluorescent particle includes one or more fluorescent moieties. In embodiments, the second fluorescent particle includes a first fluorescent moiety and a second fluorescent moiety. In embodiments, the first fluorescent moiety of the second fluorescent particle emits in a first wavelength range and the second fluorescent moiety of the second fluorescent particle emits in a second distinct wavelength range.

In embodiments, the method includes directing an excitation light to the first fluorescent particle. In embodiments, the method includes directing an excitation light to the second fluorescent particle. In embodiments, the method includes directing an excitation light to the first fluorescent particle and second fluorescent particle. In embodiments, the method includes detecting an emission light from the first fluorescent particle. In embodiments, the method includes detecting an emission light from the second fluorescent particle. In embodiments, the method includes detecting an emission light from the first fluorescent particle and second fluorescent particle.

In embodiments, detecting an emission light includes using a detection apparatus including at least one camera. In embodiments, the detection apparatus includes at least two cameras including a first camera and a second camera and wherein the first camera and the second camera are each configured to obtain an image of two different color channels. In embodiments, the first camera collects an image of first and second fluorescent channels and the second camera collects an image of third and fourth fluorescent channels.

In embodiments, the detection apparatus (alternatively referred to as an imaging system) includes at least one camera. In embodiments, the detection apparatus includes at least two cameras. For example, the detection apparatus includes a first camera and a second camera and wherein the first camera and the second camera are each configured to obtain an image of two different color channels. In embodiments, the first camera collects an image of first and second fluorescent channels and the second camera collects an image of third and fourth fluorescent channels. In embodiments, a fluorescent channel refers to a specified range of wavelengths within the electromagnetic spectrum, typically corresponding to a distinct color of light. Each channel is used to capture or detect signals from a particular fluorescent dye or fluorophore that emits light at a unique wavelength when excited by a light source. In multi-channel fluorescence imaging, different fluorophores are used to label various targets within a sample, with each fluorophore emitting light within a defined wavelength range (channel). The channels are spectrally distinct, meaning that they do not overlap significantly in the wavelengths they cover, allowing for the independent detection of multiple fluorophores in a single sample.

In embodiments, imaging includes repeated detecting emissions in different z planes, for example using a step size in the z-axis. In embodiments, the step size in the z-axis is about 50 nm, about 100 nm, about 200 nm, about 300 nm, about 400 nm, about 500 nm, about 600 nm, about 700 nm, about 800 nm, about 900 nm, or about 1000 nm. In embodiments, the step size in the Z-axis is about 50 nm, about 100 nm, about 200 nm, about 300 nm, or about 400 nm.

In embodiments, the method includes obtaining images of the tissue section along a detection axis. In embodiments, the method includes obtaining images of the tissue section along a z-axis, wherein the tissue section is on an image plane (e.g., an xy plane). In embodiments, the method includes obtaining images of the tissue section along the z-axis with a step size of about 50 nm, about 100 nm, about 200 nm, about 300 nm, about 400 nm, about 500 nm, about 600 nm, about 700 nm, about 800 nm, about 900 nm, or about 1000 nm. In embodiments, the method includes obtaining images of the tissue section along the z-axis with a step size of about 50 nm, about 100 nm, about 150 nm, about 200 nm, about 250 nm, about 300 nm, about 350 nm, about 400 nm, about 450 nm, about 500 nm, about 550 nm, about 600 nm, about 650 nm, about 700 nm, about 750 nm, about 800 nm, about 850 nm, about 900 nm, about 950 nm, or about 1000 nm. In embodiments, the method includes obtaining images of the tissue section along the z-axis with a step size of about 50 nm. In embodiments, the method includes obtaining images of the tissue section along the z-axis with a step size of about 100 nm. In embodiments, the method includes obtaining images of the tissue section along the z-axis with a step size of about 150 nm. In embodiments, the method includes obtaining images of the tissue section along the z-axis with a step size of about 200 nm. In embodiments, the method includes obtaining images of the tissue section along the z-axis with a step size of about 250 nm. In embodiments, the method includes obtaining images of the tissue section along the z-axis with a step size of about 300 nm. In embodiments, the method includes obtaining images of the tissue section along the z-axis with a step size of about 350 nm. In embodiments, the method includes obtaining images of the tissue section along the z-axis with a step size of about 400 nm.

In embodiments, the method includes using an algorithm to estimate the width of the fluorescent particles along the z-axis taken at half its maximum intensity (i.e., full width at half maximum; abbreviated as FWHM).

In embodiments, the method includes partitioning the first image and second image into a plurality of registration subimages on a computer.

In embodiments, the method includes quantifying a signal level of each position.

In embodiments, aligning includes correcting for axial and lateral chromatic aberrations based on the relative positions of the fluorescent particles in the first and second images.

In embodiments, the method includes storing a data representation of the image of the object in a computer readable memory.

### EXAMPLES

### Example 1. Method for Accurate Measurement of Tissue Thickness

For a plethora of spatial biology workflows, it is necessary to prepare sections of tissue into thin sections to adhere them onto a solid support for biomarker staining, imaging, and analysis. However, the ability to extract disease relevant insights from spatial biology workflows could be complicated by tissue heterogeneity within a tissue section and between tissue sections of the same tissue type or disease model. Heterogeneity stemming from within a tissue section is manifested by the local tissue architecture (e.g., micro-folds, voids, and gradients of cellular components within a sample). Factors contributing to heterogeneity between tissue sections could include tissue thickness as well as gradients of cellular components within a given tissue section compared to other tissue sections of the same tissue type or disease model.

Previously, variations in thickness of tissue sections have been shown to affect the detection of disease relevant biomarkers in certain tissues. For example, Libard et al. demonstrated that the stained area fraction of the brain tissue with hyperphosphorylated tau and the stained area fraction of the brain tissue with amyloid-β increased when using a 7 μm thick section compared to a 4 μm thick section (see, Libard et al. Histochem Cell Biol. 2019 January; 151(1):91-96). As shown by Libard et al., having a highly precise measurement of tissue thickness prior to performing tissue staining and analysis is essential as miscalculation in tissue thickness or variation in tissue thickness could impact detection of disease relevant biomarkers and/or accurate assignment of stage or grade of a disease. As such, the development of compositions, systems, and methods supporting accurate real-time measurement of tissue thickness and tissue topology for tissue staining protocols (e.g., tissue staining for immunohistochemical and/or in situ spatial biology workflows), image acquisition of image stained from experimental workflows (e.g., in situ spatial sequencing workflows), and/or image analysis of stained tissue is greatly needed.

Described herein are compositions, systems, devices (e.g., non-transitory computer-readable medium as described herein) and methods directed to accurately measuring tissue thickness of tissue sample on an imaging device prior to image acquisition for in situ spatial sequencing workflows. In embodiments, compositions, systems, devices, and methods described herein could be utilized to obtain quality control metrics of the tissue sample prior to imaging the tissue sample described herein. In embodiments, compositions, systems, devices, and methods described herein could be utilized to obtain quality control metrics of the tissue sample prior executing in situ spatial sequencing workflows. In embodiments, compositions, systems, devices, and methods described herein could be utilized to obtain quality control metrics of the tissue sample prior executing immunohistochemical workflows.

Briefly, the measurement of tissue thickness and tissue topology using compositions, systems, and methods described herein are as follows. The approach is particularly well-suited to fragile biological sections where direct contact or mechanical measurement (e.g., profilometry) may be infeasible or impractical.

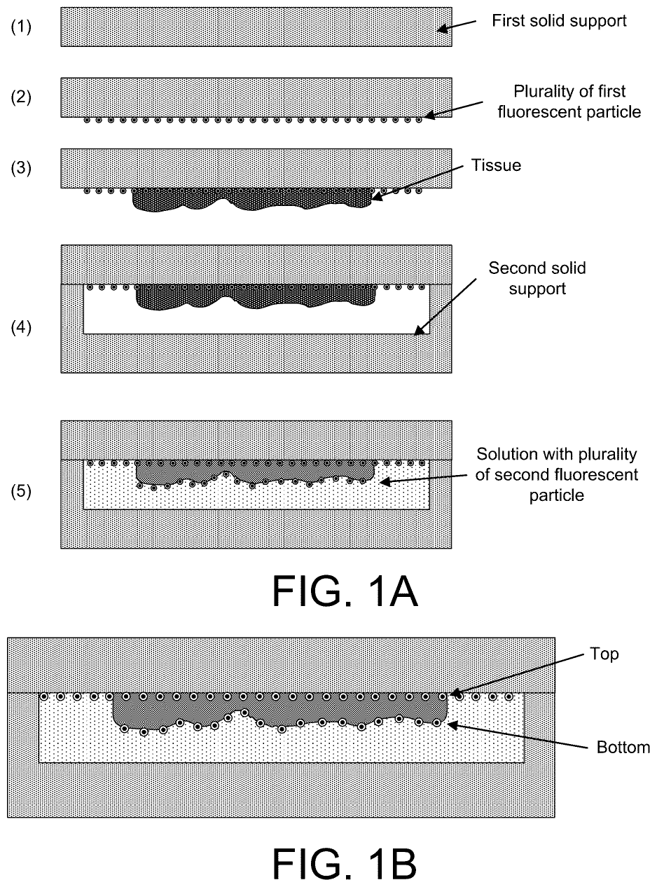

Sample preparation: FIG. 1A provides a schematic for preparing a composition described herein, wherein the composition includes a first solid support including a plurality of a first fluorescent particle attached to the first solid support, a tissue section immobilized to the first solid support, a plurality of a second fluorescent particle, and a second solid support. A sample slide with a known refractive index (e.g., a first solid support as described herein, such as a glass slide about 75 mm by about 25 mm) is prepared, wherein the slide includes a resist as described herein. A plurality of focusing beads (e.g., a plurality of first fluorescent particles as described herein) is distributed across the surface of the resist as shown in step 2 of FIG. 1A. In embodiments, the density of beads deposited on the side is about 10,000 beads per tile during imaging. In embodiments, the density of beads deposited on the side is about 300-3,000 beads per tile during imaging. In embodiments, the dimension of a tile is 1.0×1.7 cm. Following the deposition of the plurality of the first fluorescent particle at the optimal density, a tissue section as described herein is adhered onto the first solid support, followed by the affixing the second solid support onto the first solid support (as shown in steps 3 and 4 in FIG. 1A), wherein the second solid support includes drilled ports and/or fluidic channels. After affixing the second solid support to the first solid support, a solution including a plurality of the second fluorescent particle as described herein is pushed through the channel of the second solid support to facilitate adherence of the second fluorescent particle to exposed regions of the tissue section (as shown as step 5 of FIG. 1A). Alternatively, in embodiments, after adhering the tissue section onto the first solid support, a solution including a plurality of the second fluorescent particle as described herein is introduced to facilitate adherence of the second fluorescent particle to exposed regions of the tissue section. FIG. 1B provides the orientation of the tissue slide including the plurality of the first fluorescent particle and the plurality of the second fluorescent particle. The top of the tissue slide corresponds to the interface between the tissue section and the first solid support, and the bottom of the tissue slide corresponds to the interface between tissue section and the second solid support.

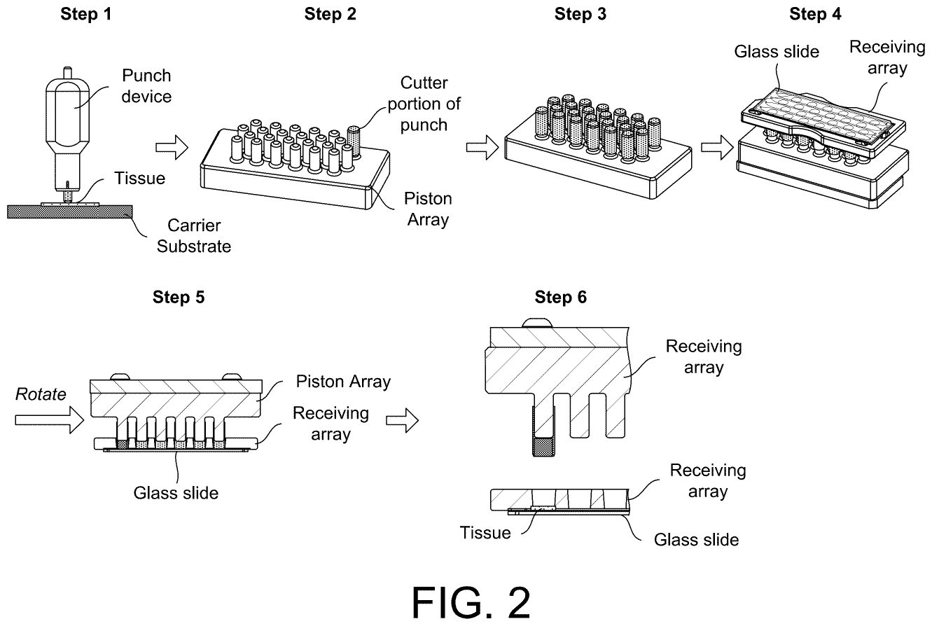

The method described herein builds on standard pathology protocols for sectioning formalin-fixed paraffin-embedded (FFPE) samples blocks on a microtome, followed by floating the individual sections in a water bath and then capturing each section using a carrier substrate made of firm gel. In embodiments, the tissue sample described herein is a fresh frozen tissue sample and is sectioned into 10-20 μm thick sections using a cryostat. In embodiments, the tissue sample described herein is a FFPE sample and is sectioned into 10-20 μm thick sections using a vibrating blade microtome. FIG. 2 illustrates a punch device used to cut out a region of tissue with desired characteristics to be used with the composition, systems, and methods described herein (e.g., shown as step 3 in FIG. 1A). The cutter portion of the punch provided in FIG. 2 is removed, flipped, and placed in a receiving array holding the first solid support described herein (as shown in steps 1-4 in FIG. 2). After the punch devices are loaded, a glass slide (e.g., a first solid support as described herein) in a holder is aligned over the tissue array (as shown in step 4 of FIG. 2). An array of pistons plunges into the punch device to push tissue samples onto the glass surface from the carrier side (as illustrated in step 4 of FIG. 2). Following incubation on a heat plate (e.g., heating the assembly for 2-4 hours at 60° C.), the receiving array, pistons, and punch devices are removed such that the sample is retained on the sample slide (e.g., the first solid support as described herein as shown in steps 5 and 6 of FIG. 2). The embedding material may be removed, for example when the embedding material is paraffin wax by contacting the construct with an organic solvent such as xylene or heptane, leaving the biological sample on the construct. In embodiments, following the adhesion of the tissue sample on the sample slide (e.g., the first solid support described herein), a second plurality of focusing beads are distributed on the surface of the tissue. In embodiments, following the adhesion of the tissue sample on the sample slide (e.g., the first solid support described herein), the sample slide is contacted with a second solid support as described herein and a second plurality of focusing beads are distributed on the surface of the tissue as shown in FIG. 1A.

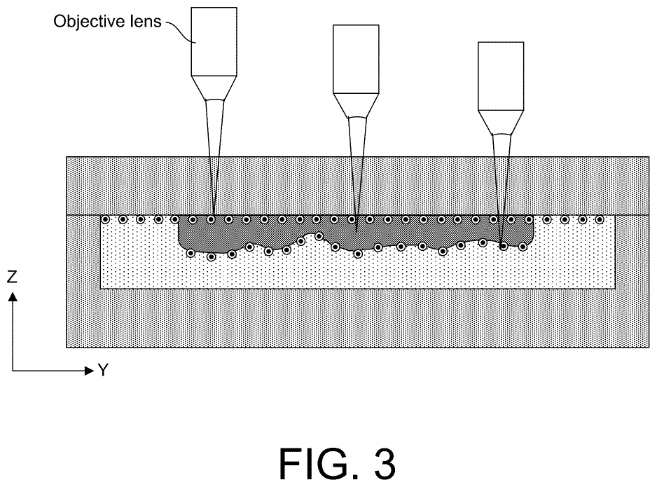

Image Acquisition: To measure the thickness and topography of a tissue section, it is imaged throughout its entire thickness as illustrated in FIG. 3 (e.g., the tissue is imaged across the entire cross section of the tissue sample and across the entire surface area of the tissue sample). In embodiments, the tissue section is imaged with a minimum of 2 steps above the absolute top of the tissue section and 2 steps below the absolute bottom of the tissue section to facilitate accurate use of a second order fit for peak finding refinement during image analysis. In embodiments, the tissue section is imaged at least 3 μm above the absolute top of the tissue section and at least 3 μm below the absolute bottom of the tissue section. In embodiments, the tissue section is imaged at least 3 μm above the absolute top of the tissue section and at least 5 μm below the absolute bottom of the tissue section. In embodiments, the tissue section is imaged 5 μm above the absolute top of the tissue section and 8 μm below the absolute bottom of the tissue section. To image across the entire thickness of the tissue section, images of the tissue section are obtained along the z-axis at defined step sizes. The step size is selected such that focal planes in at the top and bottom orientations of the tissue slide are accurately identified and that the least number of steps are used to minimize photodamage to the tissue section. During image acquisition along the z-axis, the encoder position of the stage that moves the objective lens is monitored and scaled by the index of refraction of the first solid support; this scaling is necessary to correlate the difference in the physical location of the objective lens resulting from moving the objective lens with defined step sizes along the z-axis to the actual distance imaged through the first solid support during image acquisition. FIG. 3 illustrates the movement of the objective lens along the z-axis at defined step sizes to focus on the first fluorescent particle and second fluorescent particle through the entire cross section of the tissue section across its entire surface area. As the objective lens moves along the z-axis to a (n) step defined by the step size, images are acquired iteratively, wherein an image is acquired by focusing on the first fluorescent particle and/or second fluorescent particle prior to the acquisition of the image of the tissue section at the (n+1) step.

Image Analysis: In order to analyze images of a tissue section, wherein the images are taken by focusing on the first fluorescent particle from above of the tissue section (i.e., the top orientation of the tissue slide as shown in FIGS. 1B and 3) and through below the tissue section (i.e., the bottom orientation of the tissue as shown in FIGS. 1B and 3) by focusing on the second fluorescent particle, the images are partitioned into overlapping regions of interest (ROIs) or subimages. In embodiments, images are partitioned into overlapping ROI windows measuring 500×500 pixels (156 μm²) and shifted in 200 pixels (63 μm) increments across the field of view for the imaged tissue section. The amount of overlap between ROIs is predicated by the size of each ROI and the stride, i.e., the shift, from one ROI to the next ROI in both axes (e.g., the vertical and horizontal axes). For each ROI of every cross section through the tissue obtained along the z-axis, a background subtraction and Gaussian blur is applied to the raw image to reduce the signal contribution from the tissue section itself. After background subtraction and filtering, the Laplacian Operator is determined to facilitate edge detection, and its variance is extracted.

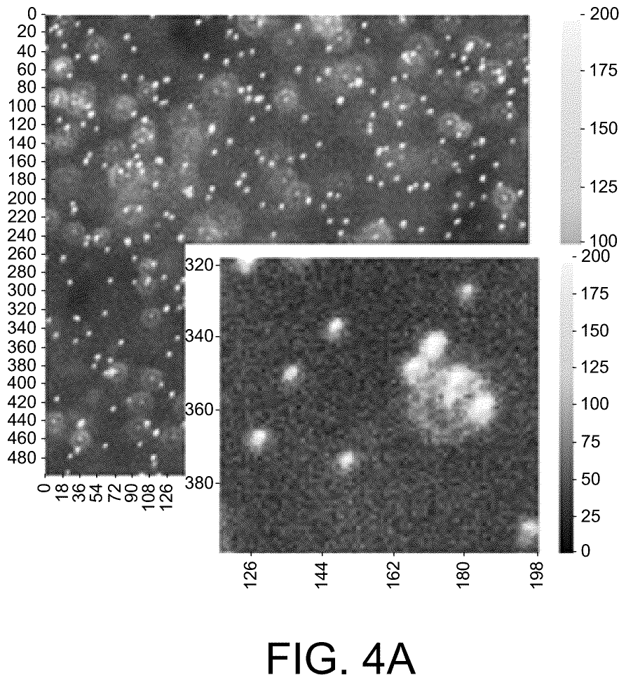

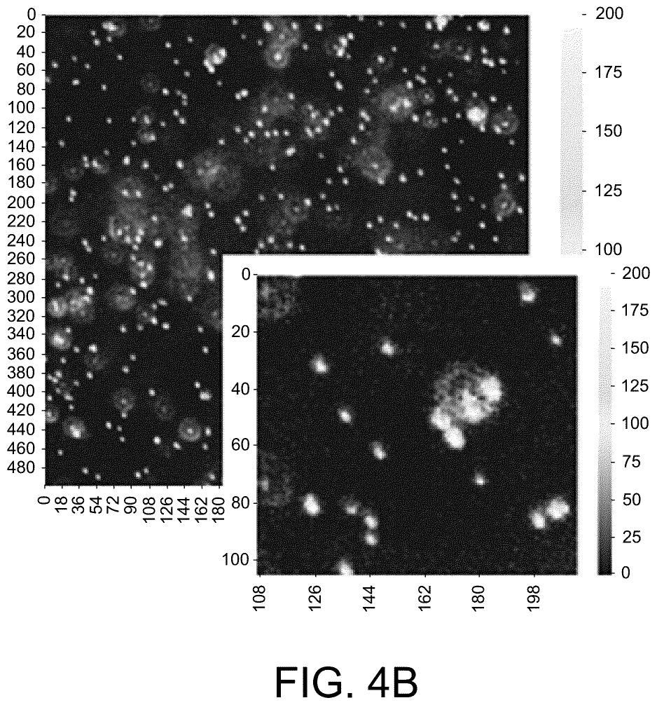

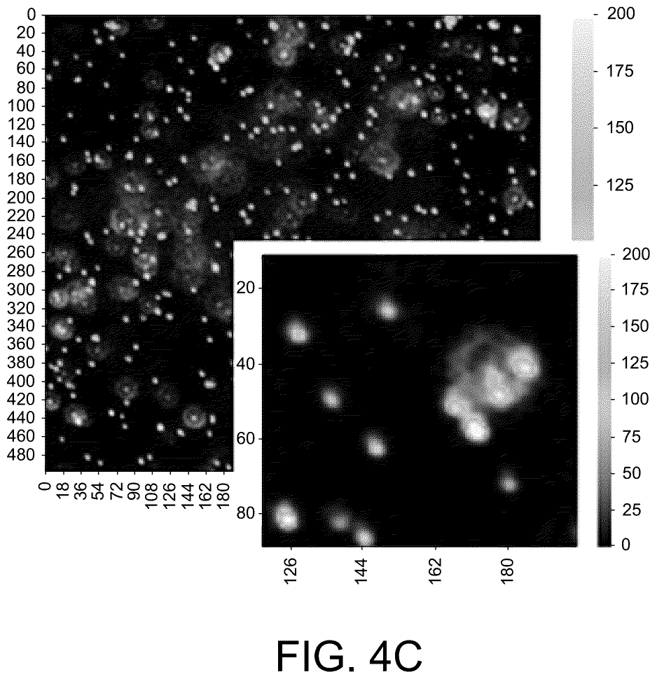

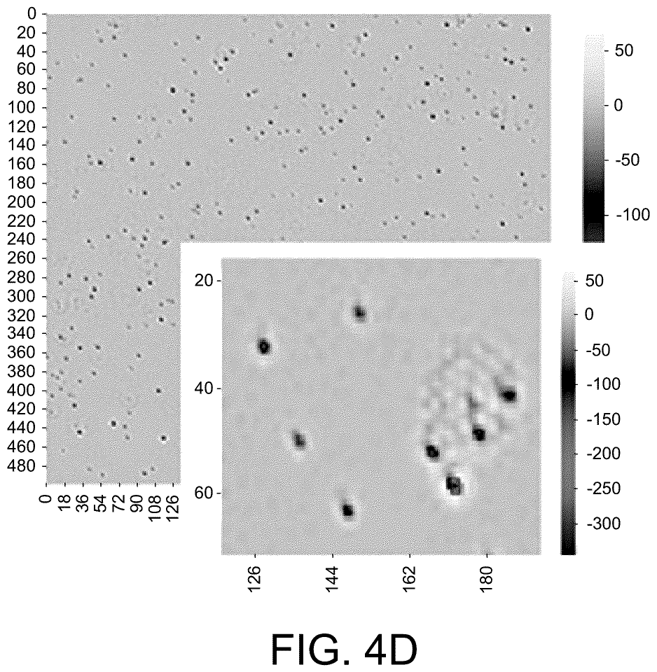

FIGS. 4A-4D provides a region of interest (ROI) throughout imaging processing. FIG. 4A provides the raw image of the ROI prior to any image processing described herein. FIG. 4B provides the ROI following the application of a background subtraction described herein. FIG. 4C provides the ROI following the application of a background subtraction described herein and a low-pass filter such as a Gaussian blur to reduce noise that is not associated with the focus feature (i.e., the first fluorescent particle and/or second fluorescent particle). FIG. 4D provides the ROI following the calculation of a Laplacian Operator and the variance of the Laplacian Operator to facilitate edge detection. As shown in FIG. 4D, the edges of the focus features and the variance of the Laplacian Operator as the focus features become more in focus.

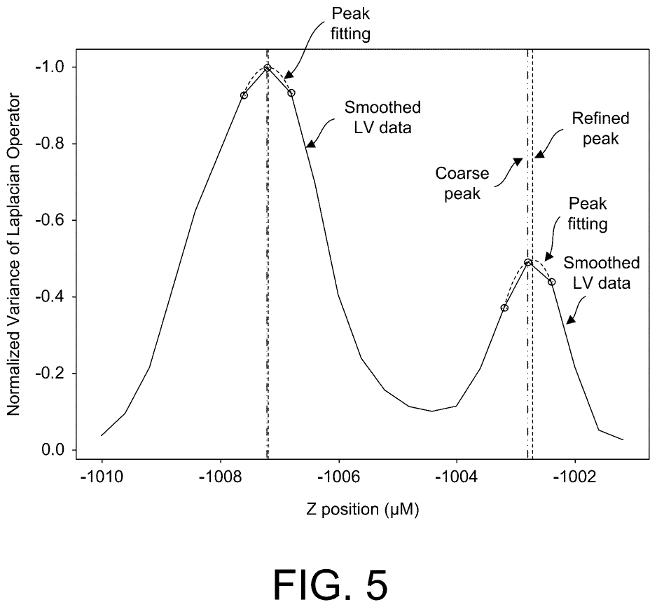

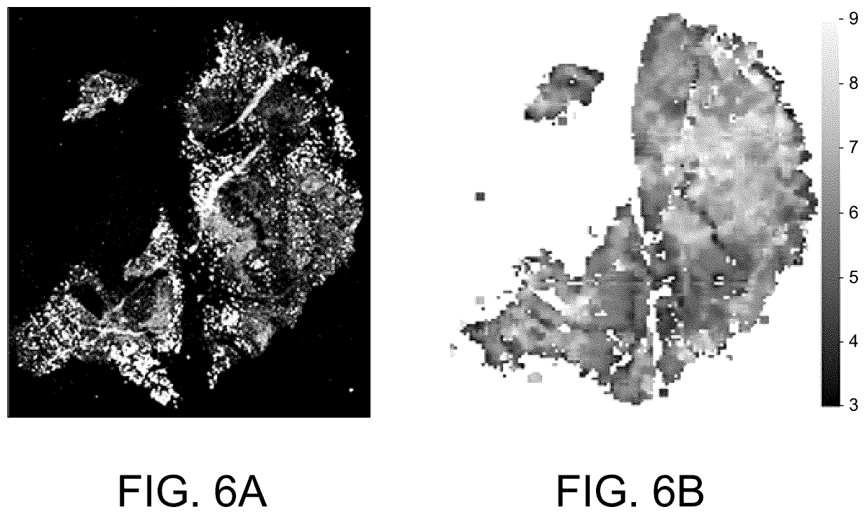

FIG. 5 provides the plot of the variance of the Laplacian Operator against the z-position (μm) for a single ROI to determine the tissue thickness at a given ROI. Plotting the variance of the Laplacian Operator (LV), for a specific ROI, against the z-position, (derived from the encoder of the stage operating the objective lens position and scaled by index of refraction of the first solid support), peaks are observed. The measurement of tissue thickness at a given ROI begins with the initial identification of coarse peaks, followed by refining the peaks positions by applying second order polynomial fits about the initial peak positions. Using the method described herein, the z-position corresponding to where the first fluorescent particle and/or second fluorescent particle are in focus can be ascertained with a resolution that significantly exceeds the step size of the cross-section (z) stack. FIG. 5 shows two peaks and the distance between these two peaks is the inferred tissue thickness at a given ROI. In embodiments, the calculation of tissue thickness further includes calculating the difference of the peaks that are scaled by the refraction index of tissue, where the refraction index of tissue is 1.33. By compiling the tissue thickness across all ROIs, the topology of the section can be reconstructed as shown in FIGS. 6A and 6B.

FIG. 6A provides a fluorescent microscope image of a single cross section. FIG. 6B shows a reconstructed topological heatmap of the section shown in FIG. 6A using the image acquisition and image analysis methods described herein. The heatmap scale is provided in μm.

### Example 2. Measurement of Tissue Thickness with Image Acquisition and Image Analysis Variables

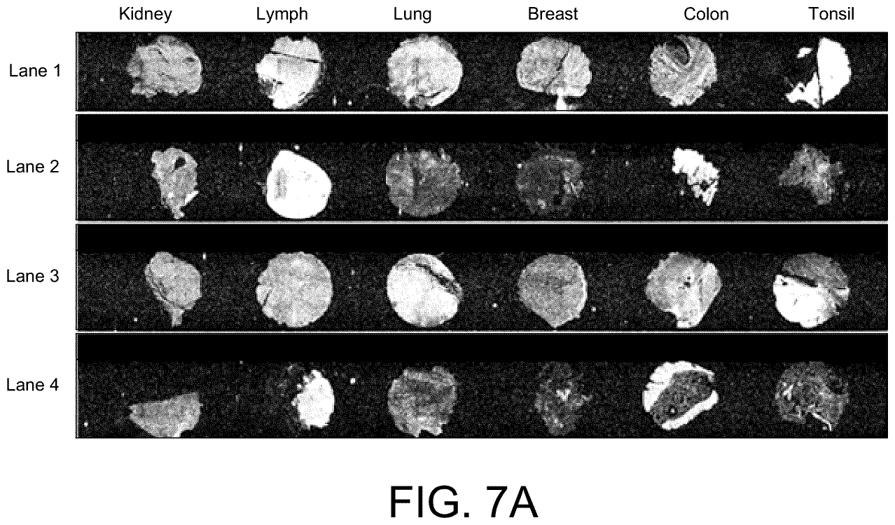

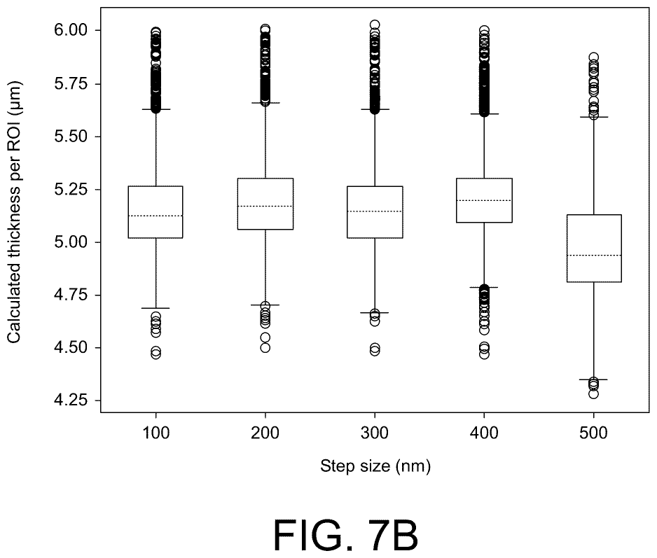

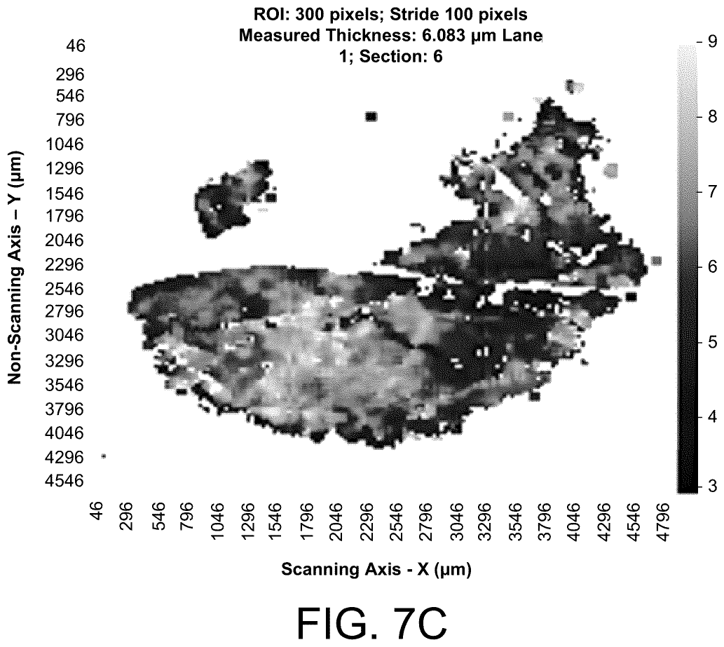

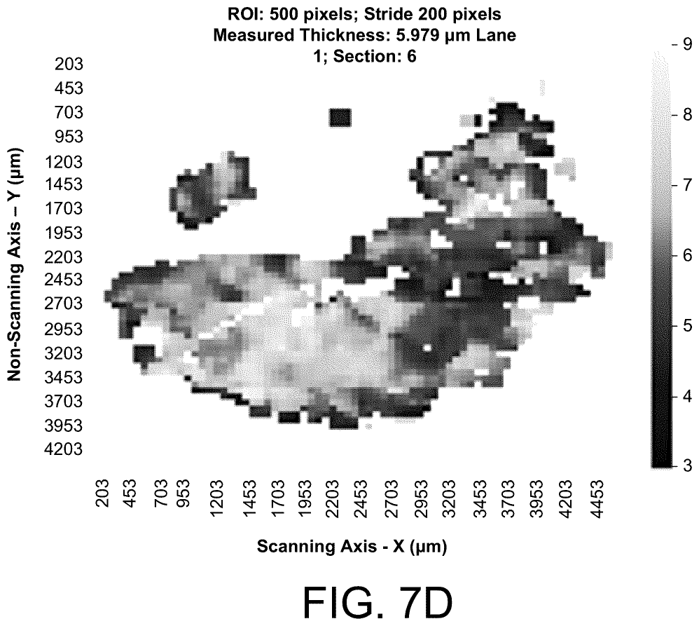

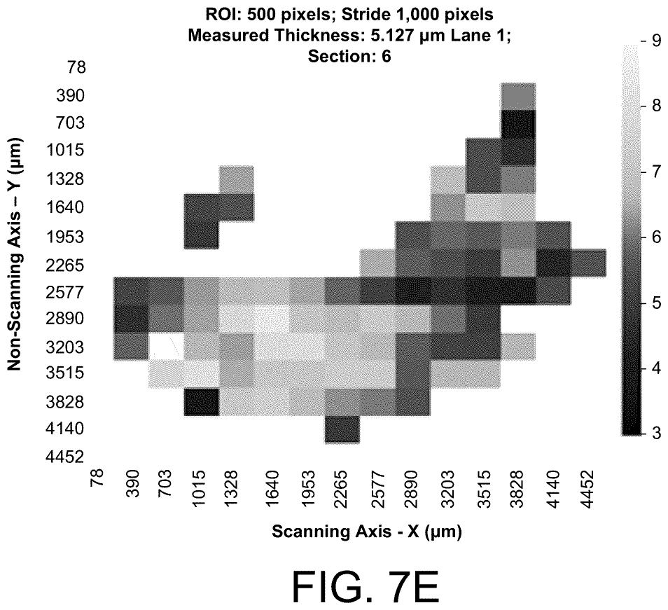

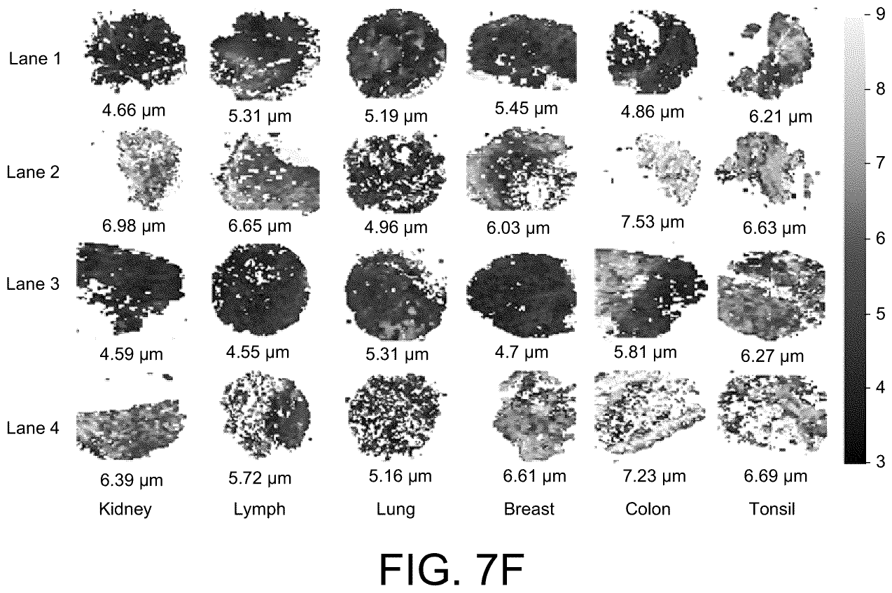

Using the methods described in Example 1, tissue sections from kidney, lymph, lung, breast, colon, and tonsil were prepared for adherence onto a flow cell (e.g., the first solid support described herein) for imaging and measurement of tissue thickness. For this study, a total of 24 tissue punches were deposited onto lanes of a 4-lane flow cell as shown in the stitched fluorescent image montage shown in FIG. 7A, where each lane included a tissue punch from each tissue type. Four tissue sections were imaged for each tissue type (e.g., four kidney punches were used, where one punch of the kidney section was adhered onto the surface of each lane of the 4-lane flow cell shown in FIG. 7A). Image acquisition for each tissue section was performed as described in Example 1 but with varying step sizes during image acquisition and variable ROI and stride configurations during image analysis.

Step size is a critical variable for image acquisition as optimal step sizes are important for obtaining high resolution of the first fluorescent particle and/or second fluorescent particle during image acquisition while minimizing unnecessary photodamage to the tissue sample during image acquisition. Varying the step size enables modulation of the distance that the objective lens moves along the z-axis between each recorded image. FIG. 7B provides box and whisker plots for calculated thickness of a section of kidney tissue per ROI on the flow cell, wherein the image was acquired with 100 nm, 200 nm, 300 nm, 400 nm, and 500 nm step sizes. As shown in FIG. 4B, step sizes exceeding 400 nm results in high variability in measured tissue thickness.

FIGS. 7C-7E demonstrates the impact of ROI size and stride length on spatial resolution of topological mapping of the tonsil tissue section in lane 1 (denoted as Lane 1; Section 6). Topological heatmaps show the non-scanning axis (μm) plotted against the scanning axis (μm), and the scale of the heatmap is provided in μm. FIG. 7C provides a calculated measured thickness of 6.083 μm when using a ROI window of 300 pixels and stride length of 100 pixels. FIG. 7D provides a calculated measured thickness of 5.979 μm when using a ROI window of 500 pixels and stride length of 200 pixels. FIG. 7E provides a calculated measured thickness of 5.127 μm when using a ROI window of 500 pixels and stride length of 1,000 pixels. As shown in FIGS. 7C-7E, the increase of ROI size ad stride length correlates to reduced spatial resolution and increased variability in the mean measured tissue thickness.

FIG. 7F shows a reconstructed topological heatmap of the tissue sections shown in FIG. 7A using the image acquisition and image analysis methods described herein. The heatmap scale is provided in μm. Calculated thickness for each tissue section is shown beneath each tissue section.

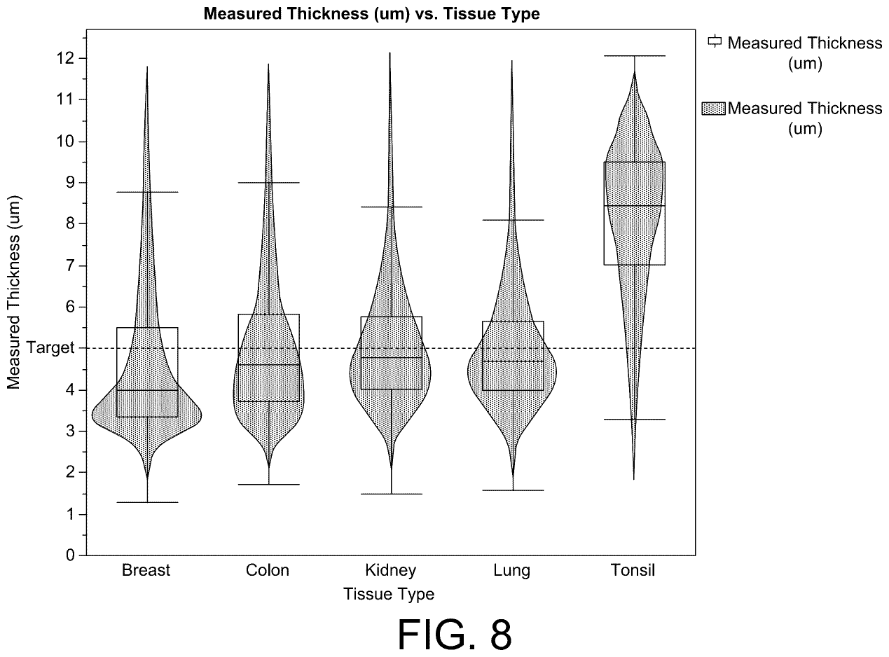

Sequencing performance is sensitive to tissue section thickness. Thin sections may suffer from lower throughput, while thick sections may suffer from reduced detection efficiency. Lymphoid organs are designed to accommodate fluid buildup by swelling and contracting as part of their normal processes. Even after FFPE processing, the structural features of lymphoid tissues (high cellularity, and hydration dependent architecture) still accommodate these swelling mechanisms, which make them more prone to thickness variability compared to other tissues. These mechanisms can increase the likelihood that we observe a difference between the sectioned thickness and measured thickness at sequencing start, which can impact performance. Due to this biological function of lymphoid tissue, we recommend treating it differently than non-lymphoid tissue. Using the methods described herein, we were able to understand this difference within lymphoid tissues. G4X sequencing performance is optimized for tissue sections that are 5 μm thick at sequencing start, however, not all samples sectioned at 5 μm remain at 5 μm throughout sample preparation. We've measured tissue thickness at sequencing start across several tissue types. The results are summarized in FIG. 8. Colon (n=4), kidney (n=12), lung (n=8), and breast (n=8) tissue sections are close to our recommended 5 μm thickness. However, lymphoid tissue, represented by tonsil (n=22), is significantly thicker. This difference between sectioned thickness and measured thickness at sequencing start can push samples sectioned at 5 μm outside the range where we observed optimal performance. In our experience, sectioning lymphoid tissues at 3 μm has the highest likelihood of achieving our recommended 5 μm measured thickness at sequencing start. Sectioning lymphoid tissue at 3 μm is a good starting point, but section thickness may need to be optimized for the sample of interest.

### Example 3. Autofocus-Based Measurement of Tissue Thickness Via Refractive Index Differentiation

Accurate quantification of tissue thickness is essential for reproducible staining, imaging, troubleshooting, and molecular profiling in spatial biology workflows. Variability in section thickness has been shown to influence biomarker detection and quantification, particularly in immunohistochemistry and spatial transcriptomics. Here, we describe an optical method that leverages a laser-based autofocus (AF) system for non-contact, high-resolution measurement of tissue thickness in formalin-fixed, paraffin-embedded (FFPE) tissue sections. The approach exploits refractive index contrasts between air, tissue, and the underlying substrate to delineate section boundaries and reconstruct topographical maps of mounted samples.

The autofocus system employed consists of a digital, tracking autofocus sensor capable of real-time measurement of both the distance to and direction of best focus. The sensor operates via through-the-lens (TTL) triangulation, whereby an 850 nm laser beam is projected through the microscope objective, reflected from the sample, and returned along the same optical path to a dedicated detection sensor. The returned signal is analyzed to determine deviations from best focus based on the shape and displacement of the laser spot. A sharply focused dot corresponds to the optimal focal plane, whereas an offset or elongated shape indicates displacement above or below the focal surface. The system provides continuous focus correction through a closed feedback loop that integrates a motorized Z-stage, a controller, and the AF sensor. The laser beam is aligned to the optical axis and configured to occupy approximately half the diameter of the back aperture of the objective lens to minimize aberrations. Optical alignment is maintained to ensure coaxiality between the objective, tube lens, and image sensor.

The AF sensor is sensitive to refractive index transitions, enabling it to resolve interfaces between media of differing optical densities. The refractive index of paraffin-embedded tissue, which closely approximates that of paraffin wax (˜1.45-1.47), contrasts with air (˜1.0003) and borosilicate glass (˜1.5). These differences produce discrete focal discontinuities that can be optically resolved without reliance on staining or structural features.

To illustrate this application, an FFPE human tonsil tissue block is sectioned at 5 μm using a rotary microtome and mounted onto a high-reflectivity (e.g., IR-reflective) borosilicate glass slide. Sections are subjected to the transfer protocol and deparaffinization protocols described above, followed by drying in a humidity-controlled chamber. The slide is then loaded onto the G4X stage equipped with the autofocus module.

A grid-based raster scan is performed, collecting autofocus measurements every 100 μm across the entire tissue section. At each grid point, the AF sensor measures the relative positions of the air-tissue and tissue-glass interfaces, producing a localized thickness value. These values are assembled into a spatially resolved thickness map using bicubic interpolation. In this representative example, tissue thickness varies from 4.6 μm to 6.3 μm, with notable thinning near the section edges and minor undulations adjacent to follicular structures.

The thickness map is further analyzed using a quality control algorithm that identifies regions deviating by more than 20% from the target thickness. Such regions can be excluded from downstream image acquisition or analysis, or flagged for re-sectioning if necessary. Moreover, the thickness data can be incorporated into subsequent image registration or deconvolution steps to account for axial heterogeneity, improving spatial fidelity and analytical robustness.

This autofocus-based thickness profiling method offers a non-destructive, label-free, and automated approach to characterize FFPE tissue sections prior to high-resolution imaging or molecular interrogation. By capturing spatial variation in tissue thickness with micron-scale resolution, this method provides a critical layer of quality control that enhances the reproducibility and interpretability of spatial omics and histopathological workflows.

What is claimed is:

1. A method of measuring a tissue topology, the method comprising:
distributing a first plurality of fluorescent particles across a first surface of a first solid support;
adhering a tissue sample to the first solid support;
attaching a second solid support to the first solid support;
introducing a solution to the second solid support wherein solution includes a second plurality of fluorescent particles that adhere to an exposed region of the tissue sample;
iteratively acquiring images of the first plurality of fluorescent particles and the second plurality of fluorescent particles across a cross section of the tissue sample.

2. The method of claim 1, further comprising obtaining an image of the tissue sample.

3. The method of claim 1, wherein the images of the first plurality of fluorescent particles and the second plurality of fluorescent particles are acquired using an objective lens that moves along a z axis at defined steps focused on the first plurality of fluorescent particles and/or the second plurality of fluorescent particles.

4. The method of claim 3, wherein the images are acquired across an entire cross section of the tissue sample and across an entire surface area of the tissue sample.

5. The method of claim 1, wherein introducing a solution to the second solid support comprises flowing a solution through at least one channel of the second solid support.

6. The method of claim 5, wherein the solution is introduced into the at least one channel via at least one port of the second solid support.

7. The method of claim 1, further wherein the first plurality of fluorescent particles attach to the tissue sample.

8. The method of claim 1, wherein the first solid support is a sample slide.

9. The method of claim 1, wherein the first plurality of fluorescent particles includes focusing beads.

10. The method of claim 1, wherein adhering a tissue sample to the first solid support comprises adhering the tissue sample to a resist positioned on the first surface of the first solid support.

11. The method of claim 1, wherein a top of the first solid support corresponds to an interface between the tissue sample and the first solid support, and the bottom of the first solid support corresponds to an interface between tissue section and the second solid support.

12. The method of claim 1, further comprising obtaining the tissue sample by cutting a region of tissue with a cutter of a punch device such that the tissue sample is retained within the cutter.

13. The method of claim 12, further comprising placing the cutter with the tissue sample onto a receiving array.

14. The method of claim 13, further comprising aligning the first solid support to the receiving array.

15. The method of claim 14, wherein adhering a tissue sample to the first solid support comprising using a plunger to push the tissue sample out of the cutter onto the first solid support.

16. The method of claim 15, further comprising heating the receiving array, the plunger and the first solid support.

17. The method of claim 16, further comprising removing the removing the receiving array, the piston, and the plunger from the first solid support such that the tissue sample is retained on the first solid support.

18. A method of measuring a tissue sample attached to a solid support, the method comprising:
positioning the solid support on a sample stage of a device comprising an imaging system;
detecting, with the imaging system, a first focal position at a first interface of the tissue sample;
detecting, with the imaging system, a second focal position at a second interface of the tissue sample;
determining, by the imaging system, a thickness of the tissue sample based on a displacement between the first focal position and the second focal position.
